(19) United States
(12) Patent Application Publication
(10) Pub. No.: US 2025/0145804 A1
(43) Pub. Date: May 8, 2025

(54) MELT-PROCESSABLE CELLULOSE ESTER COMPOSITIONS, MELTS AND MELT-FORMED ARTICLES MADE THEREFROM

(71) Applicant: Eastman Chemical Company, Kingsport, TN (US)

(72) Inventors: STEPHANIE KAY CLENDENNEN, KINGSPORT, TN (US); RAHUL SHANKAR, KINGSPORT, TN (US); HAMID EBRAHIMI, KINGSPORT, TN (US); MICHAEL EUGENE DONELSON, KINGSPORT, TN (US)

(73) Assignee: Eastman Chemical Company, Kingsport, TN (US)

(21) Appl. No.: 18/838,288

(22) PCT Filed: Feb. 14, 2023
(86) PCT No.: PCT/US2023/062552

§ 371 Date: Aug. 14, 2024

Related U.S. Application Data
(60) Provisional application No. 63/268,090, filed on Feb. 16, 2022.

(51) Int. Cl. C08L 1/12; C08J 3/075

(52) U.S. Cl. CPC C08L 1/12; C08J 3/075; C08J 2301/12; C08J 2307/00; C08L 2203/16

(57) ABSTRACT

A melt-processable, plasticized cellulose ester composition is described. The melt-processable, plasticized cellulose ester composition of the present invention includes (i) cellulose ester; (ii) plasticizer; and (iii) a hydrocolloid. Cellulose acetate melts and melt-formed articles are also described.

### BACKGROUND OF THE INVENTION

There is a well-known global issue with waste disposal, particularly of large volume consumer products such as plastics or polymers that are not considered biodegradable within acceptable temporal limits. There is a public desire to incorporate these types of wastes into renewed products through recycling, reuse, or otherwise reducing the amount of waste in circulation or in landfills. This is especially true for single-use plastic articles/materials.

As consumer sentiment regarding the environmental fate of single-use plastics, such as straws, cutlery, to-go cups, plastic bags and the like, are becoming a global trend, plastics bans are being considered/enacted around the world in both developed and developing nations. Bans have extended from plastic shopping bags into straws, cutlery, and clamshell packaging, for example, in the U.S. alone. Other countries have taken even more extreme steps, such as exemplified by a list of ten single-use articles slated to be banned, restricted in use, or mandated to have extended producer responsibilities throughout the EU. As a result, industry leaders, brand owners, and retailers have made ambitious commitments to implement compostable and/or biodegradable materials in the coming years.

Use of biodegradable, disintegratable and/or compostable materials in the manufacture of such single-use articles, though highly desirable from an environmental perspective, presents particular problems for article manufacturers. Most such articles have been manufactured historically using non-biodegradable, fossil fuel-based materials such as polystyrene and employ melt processing techniques such as casting, extrusion and injection molding, wherein the material is melted into flowable form, processed and cooled to form a functional article.

Utilizing biodegradable raw material such as plasticized cellulose esters, including plasticized cellulose acetates, as an alternative to or replacement for non-biodegradable, fossil fuel-based materials in these melt-processing applications is environmentally desirable and enhances sustainability—but is technically challenging. First, adoption of plasticized biodegradable compositions for non-biodegradable material in existing manufacturing systems may be difficult without significant equipment replacement, modification or retrofit costs. Further, changes in processing conditions that may be necessitated by use of biodegradable materials such as cellulose esters in place of non-biodegradable, fossil fuel-based materials such as polystyrene can negatively impact efficiency and material yields. In addition, the melt-processing steps for converting cellulose ester compositions into useful articles require heating the formulation to temperatures that may result in color formation, loss of compositional components such as plasticizers and loss in molecular weight of the cellulose ester, all of which affect the heat stability, toughness, flexibility and other performance parameters of the final article. Also, as biodegradation is generally a surface-driven phenomenon, thicknesses desirable for article strength may be critically limited by the desire to meet biodegradation and compostability standards.

Two important criteria that must be carefully balanced in manufacture of melt-formed articles from plasticized cellulose ester compositions are melt strength and extensibility. the extensibility of the material is an important property. Extensibility (also referred to from time to time as drawability), which generally describes a material's ability to be stretched without defect formation or failure, is critical for many if not most melt-processing methods, including foaming (wherein a material is typically heated with a foaming agent and the material stretches to form hollow cells); blow molding (wherein a material is typically heated and stretched by air blown into a preform or parison); and thermoforming (wherein a sheet is heated to a temperature above the glass transition temperature and then stretched in two dimensions to fit a mold).

With regard to thermoforming methods, a parameter known as the areal draw ratio or draw ratio is used to assess and evaluate extensibility. The areal draw ratio may be defined as the ratio of the surface area of a thermoformed article divided by the surface area of the sheet before thermoforming. By way of example, thermoformed articles like a serving tray or plate may have an areal draw ratio of less than 2, while the areal draw ratios of bowls and clamshell food containers may be about 3 and large beverage cups may have an areal draw ratio of 5 or greater.

Melt strength is also a critical parameter in melt-processing methods. Materials with high melt strength resist sagging during melt-formation processes such as thermoforming, expansion foaming, or melt spinning of fibers. Both high melt strength and high drawability are needed to generate foams with low densities.

Increasing the composition plasticizer content may improve melt flow rate and extensibility or drawability of plasticized cellulose ester compositions in some cases; however, melt strength will typically decrease steadily as plasticizer content increases.

There remains an unmet market need for single-use consumer products that have adequate performance and melt-processing properties for their intended use and that are also compostable and/or biodegradable. With particular regard to plasticized cellulose ester compositions in this field, there remains an unmet need for materials that exhibit a desirable combination of melt strength and extensibility.

It would also be beneficial to provide products having such properties and that also have significant content of renewable, recycled, and/or re-used material.

### SUMMARY OF THE INVENTION

Applicants have unexpectedly discovered that certain melt-processable plasticized cellulose ester compositions are surprisingly advantageous for use in manufacture of melt-formed biodegradable articles and biodegradable article components with unexpected processability and article property benefits.

In one aspect, the present invention is directed to a melt-processable, plasticized cellulose ester composition. The melt-processable, cellulose acetate composition of the present invention includes (i) cellulose ester; (ii) plasticizer; and (iii) a hydrocolloid.

In another aspect, the present invention is directed to a cellulose ester melt, useful in particular for forming melt-formed articles. The cellulose ester melt of the present invention includes (i) cellulose acetate; (ii) plasticizer; and (iii) a hydrocolloid.

In yet another aspect, the present invention is directed to a melt-formed biodegradable article. The melt-formed biodegradable article of the present invention includes, is formed from or prepared using a melt-processable plasticized cellulose ester composition that includes (i) cellulose ester; (ii) plasticizer; and (iii) a hydrocolloid or cellulose ester melt that includes (i) cellulose ester; (ii) plasticizer; and (iii) a hydrocolloid.

In various interrelated aspects and embodiments, the present invention is generally directed to melt-processable compositions including foamable or expandable compositions; melts; fibers, sheets, foams; articles, including melt-formed articles and articles including, formed from or prepared from melt-processable compositions and related compositions. One of ordinary skill will understand and appreciate that elements or features used to describe one aspect or embodiment may be applicable and useful in describing other embodiments. By way of non-limiting example, the description of a cellulose ester set forth in the context of the composition of the present invention is also applicable and useful in describing cellulose ester in the context of melts, extruded, spun, molded, thermoformed or expanded/foamed compositions and articles of the present invention. Accordingly, descriptions and disclosure relating to elements or features of an aspect or embodiment of the present invention are hereby expressly relied on to describe and support those elements or features in other aspects or embodiments.

In various aspects and embodiments below, the present invention is described with specificity as a cellulose acetate composition that includes cellulose acetate. It should be understood, however, that the descriptions relating to such specific embodiments are also expressly relied on to describe and support embodiments more broadly directed to cellulose ester compositions that include cellulose ester.

The present application also discloses additional compositions, melts, articles, and methods in various aspects.

### DETAILED DESCRIPTION OF THE INVENTION

In a first aspect, the present invention is directed to a melt-processable, plasticized cellulose ester composition. The melt-processable, cellulose ester composition of the present invention includes (i) cellulose ester; (ii) plasticizer; and (iii) a hydrocolloid.

The cellulose ester of the present invention may be generally described to include cellulose esters of one or more carboxylic acids and are described for example in U.S. Pat. No. 5,929,229, assigned to the assignee of the present invention, the contents and disclosure of which are incorporated herein by reference. Non limiting examples of cellulose esters include cellulose acetate, cellulose propionate, cellulose butyrate, so-called mixed acid esters such as cellulose acetate propionate and cellulose acetate butyrate and combinations thereof. In one or more embodiments, the cellulose ester is chosen from the group consisting of cellulose acetate, cellulose acetate propionate, or cellulose acetate butyrate and combinations thereof.

In one or more embodiments, the cellulose ester includes, consists essentially of or consists of cellulose acetates. In one or more embodiments, the cellulose acetate may be present in the melt-processable, plasticized cellulose acetate composition in an amount of from 50% to 97% by weight or from 55% to 95% by weight or from 60% to 90% by weight based on the total weight of the melt-processable, plasticized cellulose ester composition. Cellulose acetates that may be useful for the present invention generally comprise repeating units of the structure:

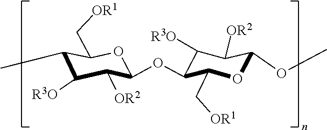

wherein R¹, R², and R³ are selected independently from the group consisting of hydrogen or acetyl. For cellulose esters, the substitution level is usually expressed in terms of degree of substitution (DS), which is the average number of non-OH substituents per anhydroglucose unit (AGU). Generally, conventional cellulose contains three hydroxyl groups in each AGU unit that cellulose acetate be substituted; therefore, DS cellulose acetate have a value between zero and three. Native cellulose is a large polysaccharide with a degree of polymerization from 250-5,000 even after pulping and purification, and thus the assumption that the maximum DS is 3.0 is approximately correct. Because DS is a statistical mean value, a value of 1 does not assure that every AGU has a single substituent. In some cellulose acetates, there cellulose acetate be unsubstituted anhydroglucose units, some with two and some with three substituents, and typically the value will be a non-integer. Total DS is defined as the average number of all of substituents per anhydroglucose unit. The degree of substitution per AGU cellulose acetate also refer to a particular substituent, such as, for example, hydroxyl or acetyl. In embodiments, n is an integer in a range from 25 to 250, or 25 to 200, or 25 to 150, or 25 to 100, or 25 to 75. Cellulose acetates useful in embodiments of the present invention cellulose acetate have a degree of substitution in the range of from 1.0 to 2.5. In some embodiments, the cellulose acetate may have an average degree of substitution of at least about 1.0, 1.05, 1.1, 1.15, 1.2, 1.25, 1.3, 1.35, 1.4, 1.45 or 1.5 and/or not more than about 2.5, 2.45, 2.4, 2.35, 2.3, 2.25, 2.2, 2.15, 2.1, 2.05, 2.0, 1.95, 1.9, 1.85, 1.8 or 1.75.

In embodiments of the invention, the cellulose acetates have at least 2 anhydroglucose rings and cellulose acetate have between at least 50 and up to 5,000 anhydroglucose rings, or at least 50 and less than 150 anhydroglucose rings. The number of anhydroglucose units per molecule is defined as the degree of polymerization (DP) of the cellulose acetate. In embodiments, cellulose acetate may have an inherent viscosity (IV) of about 0.2 to about 3.0 deciliters/gram, or about 0.5 to about 1.8, or about 1 to about 1.5, as measured at a temperature of 25° C. for a 0.25-gram sample in 100 ml of a 60/40 by weight solution of phenol/tetrachloroethane. In embodiments, cellulose acetates useful in some embodiments may have a DS/AGU of about 1 to about 2.5, or 1 to less than 2.2, or 1 to less than 1.5, and the substituting ester is acetyl. Cellulose acetates useful in some embodiments may include cellulose diacetates and cellulose triacetates. The cellulose acetate useful in some embodiments include a cellulose acetate having an average degree of substitution for acetyl substituents (“DS_{Ac}”) in the range of from 2.2 to 2.6, or from 1.7 to 2.6, or from 2.2 to 2.5, or from 2.3 to 2.6, or from 2.4 to 2.6.

Cellulose esters useful in the present invention, and particularly cellulose acetates, may be biodegradable. The term “biodegradable” generally refers to the biological conversion and consumption of organic molecules. Biodegradability is an intrinsic property of the material itself, and the material cellulose acetate exhibit different degrees of biodegradability, depending on the specific conditions to which it is exposed. The term “disintegrable” refers to the tendency of a material to physically decompose into smaller fragments when exposed to certain conditions. Disintegration depends both on the material itself, as well as the physical size and configuration of the article being tested. Ecotoxicity measures the impact of the material on plant life, and the heavy metal content of the material is determined according to the procedures laid out in a standard test method. The melt-processable compositions and the melts of the present invention, in one or more embodiments, may be biodegradable.

Cellulose esters of the present invention may be produced by any method known in the art. Examples of processes for producing cellulose esters generally are taught in Kirk-Othmer, Encyclopedia of Chemical Technology, 5th Edition, Vol. 5, Wiley-Interscience, New York (2004), pp. 394-444. Cellulose, the starting material for producing cellulose acetates, may be obtained in different grades and sources such as from cotton linters, softwood pulp, hardwood pulp, corn fiber and other agricultural sources, and bacterial cellulose, among others.

One method of producing cellulose acetates is esterification of the cellulose by mixing cellulose with the appropriate organic acids, acid anhydrides, and cellulose catalysts. Cellulose is then converted to a cellulose triester. Ester hydrolysis is then performed by adding a water-acid mixture to the cellulose triester, which cellulose acetate then be filtered to remove any gel particles or fibers. Water is then added to the mixture to precipitate the cellulose ester. The cellulose ester may then be washed with water to remove reaction by-products followed by dewatering and drying.

The cellulose triesters to be hydrolyzed have three acetyl substituents. These cellulose esters may be prepared by a number of methods known to those skilled in the art. For example, cellulose esters may be prepared by heterogeneous acylation of cellulose in a mixture of carboxylic acid and anhydride in the presence of a cellulose catalyst such as H₂SO₄. Cellulose triesters may also be prepared by the homogeneous acylation of cellulose dissolved in an appropriate solvent such as LiCl/DMAc or LiCl/NMP.

Those skilled in the art will understand that the commercial term of cellulose triesters also encompasses cellulose esters that are not completely substituted with acyl groups. For example, cellulose triacetate commercially available from Eastman Chemical Company, Kingsport, TN, U.S.A., typically has a DS from about 2.85 to about 2.99.

After esterification of the cellulose to the triester, part of the acyl substituent may be removed by hydrolysis or by alcoholysis to give a secondary cellulose ester. As noted previously, depending on the particular method employed, the distribution of the acyl substituents may be random or non-random. Secondary cellulose esters may also be prepared directly with no hydrolysis by using a limiting amount of acylating reagent. This process is particularly useful when the reaction is conducted in a solvent that will dissolve cellulose. All of these methods yield cellulose esters that are useful in this invention.

In one embodiment or in combination with any of the mentioned embodiments, or in combination with any of the mentioned embodiments, the cellulose acetates of the present invention are cellulose diacetates. The cellulose diacetates may have a polystyrene equivalent number average molecular weight (Mn) from about 10,000 to about 100,000 as measured by gel permeation chromatography (GPC) using NMP as solvent and polystyrene equivalent Mn according to ASTM D6474. In other aspects or embodiments of the present invention described herein, the melt-processable, biodegradable cellulose acetate composition of the present invention includes cellulose diacetate having a polystyrene equivalent number average molecular weights (Mn) from 10,000 to 90,000; or 10,000 to 80,000; or 10,000 to 70,000; or 10,000 to 60,000; or 10,000 to less than 60,000; or 10,000 to less than 55,000; or 10,000 to 50,000; or 10,000 to less than 50,000; or 10,000 to less than 45,000; or 10,000 to 40,000; or 10,000 to 30,000; or 20,000 to less than 60,000; or 20,000 to less than 55,000; or 20,000 to 50,000; or 20,000 to less than 50,000; or 20,000 to less than 45,000; or 20,000 to 40,000; or 20,000 to 35,000; or 20,000 to 30,000; or 30,000 to less than 60,000; or 30,000 to less than 55,000; or 30,000 to 50,000; or 30,000 to less than 50,000; or 30,000 to less than 45,000; or 30,000 to 40,000; or 30,000 to 35,000; as measured by gel permeation chromatography (GPC) using NMP as solvent and according to ASTM D6474. In embodiments, the cellulose acetate may have a number average molecular weight (Mn) of not more than 100,000, or not more than 90,000, measured using gel permeation chromatography with a polystyrene equivalent and using N-methyl-2-pyrrolidone (NMP) as the solvent. In some cellulose acetates, the biodegradable cellulose acetate may have a Mn of at least about 10,000, at least about 20,000, 25,000, 30,000, 35,000, 40,000, or 45,000 and/or not more than about 100,000, 95,000, 90,000, 85,000, 80,000, 75,000, 70,000, 65,000, 60,000, or 50,000.

The most common commercial secondary cellulose esters are prepared by initial acid catalyzed heterogeneous acylation of cellulose to form the cellulose triester. After a homogeneous solution in the corresponding carboxylic acid of the cellulose triester is obtained, the cellulose triester is then subjected to hydrolysis until the desired degree of substitution is obtained. After isolation, a random secondary cellulose ester is obtained. That is, the relative degree of substitution (DS) at each hydroxyl is roughly equal.

In embodiments of the invention, the cellulose acetate may be prepared by converting cellulose to a cellulose ester with reactants that are obtained from recycled materials, e.g., a recycled plastic content syngas source. In embodiments, such reactants may be cellulose reactants that include organic acids and/or acid anhydrides used in the esterification or acylation reactions of the cellulose, e.g., as discussed herein.

The cellulose acetates of the present invention may be produced in any physical form that is desirable for downstream processing into compositions, melts and useful articles. In one or more embodiments, the biodegradable melt-stable cellulose acetate is in the form of a powder. In one or more embodiments, the biodegradable melt-stable cellulose acetate is in the form of a flake or pellet.

In one or more embodiments, the melt-processable cellulose acetate composition includes at least one recycle cellulose acetate. In one or more embodiments, the recycle cellulose acetate includes at least one substituent on an anhydroglucose unit (AU) derived from recycled content material, e.g., recycled plastic content syngas. Recycle cellulose acetates and methods for their manufacture are described for example in present assignee's PCT Published Applications WO2020/242921; WO2021/061918A1; WO2021/092296A1 and U.S. Published Patent Application No. 2020/0247910, all expressly incorporated herein by reference.

In embodiments wherein the melt-processable, plasticized cellulose ester composition of the present invention includes a cellulose acetate, the composition may further include one or more additional cellulose esters. Non-limiting examples of such additional cellulose esters include cellulose propionate, cellulose butyrate and so-called mixed acid esters such as cellulose acetate propionate (CAP) and cellulose acetate butyrate (CAB). In embodiments wherein the melt-processable, plasticized cellulose ester composition of the present invention includes a cellulose acetate, the additional cellulose ester may include a second cellulose acetate that differs from the first cellulose acetate by one or more characteristics such as degree of substitution (DS), glass transition temperature, inherent viscosity, acid number, hydroxyl number, bulk density, molecular weight or the like.

The cellulose ester may be present in the melt-processable, plasticized cellulose ester composition in an amount of from 1% to 99% by weight based on the total weight of the composition. In one or more embodiments, the cellulose ester is present in amount of at least 50% by weight based on the total weight of the composition. One of ordinary skill will appreciate that the amount of cellulose ester in the composition may be varied based on a variety number of factors, including without limitation desired composition target properties such as crystallization, toughness, elongation, adhesion, modulus melt strength and the like. In one or more embodiments, the cellulose ester is present in an amount of at least 50% by weight based on the total weight of said composition. In one or more embodiments, the cellulose ester is present in an amount of up to 70% by weight based on the total weight of said composition. In one or more embodiments, the cellulose ester is present in an amount of up to 60% by weight based on the total weight of said composition. In one or more embodiments, the cellulose ester is present in the biodegradable composition in an amount of up to 30% by weight based on the total weight of the composition or up to 20% by weight based on the total weight of the composition or up to 10% by weight based on the total weight of the composition.

The melt-processable, cellulose acetate composition of the present invention further includes a plasticizer. Plasticizers may be used singly, or in a combination of two or more. The plasticizer may be generally described as a processing aid that for example may reduce the melt temperature, the glass transition temperature (Tg) and/or the melt viscosity of the cellulose acetate as present in the composition.

In embodiments, the plasticizer is a biodegradable plasticizer. Some examples of biodegradable plasticizers include triacetin, tripropoinin, triethyl citrate, acetyl triethyl citrate, polyethylene glycol, the benzoate containing plasticizers such as the Benzoflex™ plasticizer series, poly (alkyl succinates) such as poly (butyl succinate), polyethersulfones, adipate based plasticizers, soybean oil epoxides such as the Paraplex™ plasticizer series, sucrose based plasticizers, dibutyl sebacate, tributyrin, the Resoflex™ series of plasticizers, triphenyl phosphate, glycolates, polyethylene glycol ester and ethers, 2,2,4-trimethylpentane-1,3-diyl bis(2-methylpropanoate), polycaprolactones and combinations thereof. In one or embodiments, the plasticizer includes a plasticizer with recycle content. Plasticizers with recycle content are generally described in WO2021092321A1, assigned to the assignee of the present invention, the contents and disclosure of which are expressly incorporated herein by reference.

In embodiments, the plasticizer is a food-compliant plasticizer. The term “food-compliant” is meant to indicate compliance with applicable food additive, food contact and/or pharmaceutical and the like regulations wherein the plasticizer is cleared for use or recognized as safe by at least one (national or regional) safety regulatory agency (or organization). Food-compliant materials may include materials listed in the 21 CFR Food Additive Regulations or otherwise Generally Recognized as Safe (GRAS) by the US FDA. In embodiments, the food-compliant plasticizer is triacetin. In embodiments, examples of food-compliant plasticizers that could be considered may include triacetin, triethyl citrate, polyethylene glycol, benzoic acid esters (e.g. Benzoflex), propylene glycol, acetylated triethyl citrate, acetyl tributyl citrate, polymeric plasticizers (e.g. Admex), tripropionin, tributyrin, Saciflex, poloxamer copolymers, polyethylene glycol esters and ethers (e.g. PEG succinate), adipate esters (e.g. diisobutyl adipate), polyvinyl pyrollidone, glycerol tribenzoate and combinations thereof. In one or more embodiments, the plasticizer may be selected from the group consisting of triacetin, polyethylene glycol having an average weight average molecular weight of from 300 to 1000 Da and combinations thereof.

The melt-processable cellulose ester composition of the present invention may be plasticized. Accordingly, the plasticizer may be present in a plasticizing amount. The phrase “plasticizing amount” includes amounts of plasticizer that are sufficient to plasticize the cellulose ester present in the melt-processable cellulose ester composition to facilitate formation of a melt and melt processing of the melt into useful melt-formed articles. One of ordinary skill will appreciate that the specific amount of plasticizer that may constitute a “plasticizing amount” may depend on a number of factors such as for example cellulose ester identity and amount and identity of other additives or components present in the composition. For example, the presence of certain processing aids such as compatible polymers, solvents, and foaming agents in the composition can reduce the amount plasticizer necessary to plasticize the cellulose acetate.

In embodiments, the plasticizer may be present in an amount sufficient to permit the melt-processable, plasticized cellulose ester composition to be melt processed (or thermally formed) into useful articles, e.g., single use plastic articles, in conventional melt processing equipment. The amount of plasticizer may accordingly vary based on factors that include the type of thermal processing or melt processing used to make an article from the composition. Non-limiting processing examples include extrusion such as profile extrusion and sheet extrusion; injection molding; compression molding; blow molding; thermoforming; and the like. Accordingly, articles that may include or be formed from or be prepared using the composition may include extruded articles such as profile extruded articles and sheet extruded articles; injection molded articles; compression molded articles; blow molded articles; thermoformed articles; and the like.

In one or more embodiments, the melt-processable plasticized cellulose ester composition may include plasticizer (as described herein) in an amount of from 1 to 40 wt %, or 5 to 40 wt %, or 5% to 30%, or 10 to 40 wt %, or 13 to 40 wt %, or 15 to 50 wt % or 15 to 40 wt %, or 17 to 40 wt %, or 20 to 40 wt %, or 25 to 40 wt %, or 5 to 35 wt %, or 10 to 35 wt %, or 13 to 35 wt %, or 15 to 35 wt %, or greater than 15 to 35 wt %, or 17 to 35 wt %, or 20 to 35 wt %, or 5 to 30 wt %, or 10 to 30 wt %, or 13 to 30 wt %, or 15 to 30 wt %, or greater than 15 to 30 wt %, or 17 to 30 wt %, or 5 to 25 wt %, or 10 to 25 wt %, or 13 to 25 wt %, or 15 to 25 wt %, or greater than 15 to 25 wt %, or 17 to 25 wt %, or 5 to 20 wt %, or 10 to 20 wt %, or 13 to 20 wt %, or 15 to 20 wt %, or greater than 5 to 20 wt %, or 17 to 20 wt %, or 5 to 17 wt %, or 10 to 17 wt %, or 13 to 17 wt %, or 15 to 17 wt %, or greater than 15 to 17 wt %, or 5 to less than 17 wt %, or 10 to less than 17 wt %, or 13 to less than 17 wt %, or 15 to less than 17 wt %, all based on the total weight of the melt-processable plasticized cellulose ester composition.

The melt-processable plasticized cellulose ester composition of the present invention includes a hydrocolloid. In general, hydrocolloids are high molecular weight hydrophilic polymers that generally contain polar or charged functional groups such as for example, hydroxyl groups, rendering them soluble or dispersible in water and may be polyelectrolytes. Hydrocolloids may be of plant, animal, microbial or synthetic origin and may be classified as either protein hydrocolloids (such as gelatin, casein and some milk-, egg-, and plant- or vegetable-derived protein isolates) or polysaccharide hydrocolloids; however, one of ordinary skill in the art will appreciate that there are many types of hydrocolloids, and each type contains multiple grades within their product categories and may be processed under various conditions. Hydrocolloids may form gels by physical association of their polymer chains through one or more of hydrogen bonding, hydrophobic interactions and cation mediated cross-linking. Hydrocolloids are generally well known in the art and are described for example in WO2007/048193, WO2010/091853, and U.S. Pat. No. 6,093,439, the contents and disclosure of which are incorporated herein by reference. As used herein, the term “hydrocolloid” is expressly intended to include purified, partially purified or refined hydrocolloids; hydrocolloids that occur as a salt, such as for example sodium alginate; and chemically modified hydrocolloids and/or hydrocolloid derivatives, such as for example, hydroxypropylated starch and acacia gum modified with octenyl succinic acid.

In one or more embodiments, the hydrocolloid included in the melt-processable plasticized cellulose ester composition of the present invention may be an emulsifier or an emulsifying agent. As generally described in the art, an emulsifier is a surfactant or surface-active substance, often water-soluble or water-dispersible, which may reduce the interface tension and counteract droplet enlargement of a chemical system. An emulsifier may for example act as a stabilizer for emulsions, preventing liquids that ordinarily don't mix from separating. A hydrocolloid that is substantially surface-active may have the potential to act as an emulsifier in a formulation or composition. The most widely used polysaccharide emulsifiers in food applications are acacia gum, modified starches, modified celluloses, some kinds of pectin (e.g., sugar beet pectin), and some galactomannans (soybean soluble polysaccharide). Starch that has been hydrophobically modified by reaction with octenyl succinate anhydride has been shown to be strongly surface-active. Good stabilization by adsorbed polysaccharides can also be achieved with various surface-active derivatives of cellulose such as hydroxypropyl (methyl)cellulose, de-polymerized citrus pectin, and corn fiber gum. Polysaccharide hydrocolloids that can act as emulsifiers may include Fenugreek gum, Gum Arabic, Gum Ghatti, and Gum Karaya. Tragacanth gum, while Mesquite gum and Larchwood arabinogalactan are other polysaccharide hydrocolloid emulsifiers from tree exudates.

Further, some polysaccharide hydrocolloids may act as an emulsifier in the presence of a protein which is either blended with or chemically reacted to the polysaccharide, referred to herein as a “polysaccharide/protein emulsifier complex” wherein the complex (which also me be referred to herein as a blend or conjugate) is more surface-active than the polysaccharide alone. Examples of polysaccharide/protein emulsifier complexes include a whey protein-maltodextrin conjugate, and a blend of beta-casein with xanthan gum. As a further example, U.S. Pat. No. 8,034,394, the contents and disclosure of which are hereby incorporated herein by reference, describes a glycoprotein emulsifier which comprises at least one protein and at least one carbohydrate covalently bonded, wherein the protein is selected from the group comprising one or more of milk, plant or egg protein and the carbohydrate is selected from the group comprising one or more of simple sugars, monosaccharides, disaccharides and polysaccharides. In one or more embodiments, the hydrocolloid included in the melt-processable plasticized cellulose ester composition of the present invention may be a polysaccharide/protein emulsifier complex.

In one or more embodiments, the hydrocolloid is present in the melt-processable plasticized cellulose ester composition in an amount from 0.1 to 49% by weight or from 0.5% to 20% by weight or from 0.1% to 5% by weight based on the total weight of said melt-processable plasticized cellulose ester composition. In one or more embodiments, the hydrocolloid is present in the melt-processable plasticized cellulose ester composition in an amount no more than or an amount less than the amount of the cellulose ester in the composition. In one or more embodiments, the melt-processable plasticized cellulose ester compositions of the present invention may include more than one hydrocolloid or a blend or mixture of hydrocolloids. In such embodiments, the total hydrocolloid content in the melt-processable plasticized cellulose ester composition may be from 0.1 to 49% by weight or from 0.1% to 20% by weight or from 0.1% to 5% by weight based on the total weight of said melt-processable plasticized cellulose ester composition.

In one or more embodiments, the hydrocolloid included in the melt-processable plasticized cellulose ester composition of the present invention is a polysaccharide hydrocolloid. Examples of polysaccharide hydrocolloids include without limitation agar, alginate, carrageenan, chitin, cassia gum, cellulose gum, carboxymethyl cellulose, hydroxyethyl cellulose, hydroxypropyl cellulose, methyl cellulose, hydroxypropyl methyl cellulose, fenugreek gum, gellan gum, guar gum, acacia gum, gum arabic, gum ghatti, gum karaya, gum tragacanth, konjac mannan, linseed gum, locust bean gum, tara gum (also known as Caesalpinia spinosa gum), tamarind gum, yarrow gum, plane tree gum, xanthan gum, soybean soluble polysaccharide, pectin, starch and modified starch. In one or more embodiments, the hydrocolloid included in the melt-processable plasticized cellulose ester composition of the present invention is selected from the group consisting of agar, alginate, carrageenan, chitin, cassia gum, cellulose gum, carboxymethyl cellulose, hydroxyethyl cellulose, hydroxypropyl cellulose, methyl cellulose, hydroxypropyl methyl cellulose, fenugreek gum, gellan gum, guar gum, acacia gum, gum arabic, gum ghatti, gum karaya, gum tragacanth, konjac mannan, larchwood gum, linseed gum, locust bean gum, mesquite gum, corn fiber gum, tara gum (also known as Caesalpinia spinosa gum), tamarind gum, yarrow gum, plane tree gum, xanthan gum, soybean soluble polysaccharide, pectin, starch and modified starch. In one or more embodiments, the melt-processable plasticized cellulose ester composition of the present invention includes a hydrocolloid wherein the hydrocolloid comprises acacia gum.

In one or more embodiments, the hydrocolloid included in the melt-processable plasticized cellulose ester composition of the present invention is a food-compliant hydrocolloid. The term “food-compliant” is meant to indicate compliance with applicable food additive, food contact and/or pharmaceutical and the like regulations wherein the plasticizer is cleared for use or recognized as safe by at least one (national or regional) safety regulatory agency (or organization). Examples of food-compliant hydrocolloids include without limitation agar, alginate, carrageenan, chitin, cassia gum, cellulose gum, carboxymethyl cellulose, hydroxyethyl cellulose, hydroxypropyl cellulose, methyl cellulose, hydroxypropyl methyl cellulose, fenugreek gum, gellan gum, guar gum, acacia gum, gum arabic, gum ghatti, gum karaya, gum tragacanth, konjac mannan, linseed gum, locust bean gum, tara gum (also known as Caesalpinia spinosa gum), tamarind gum, yarrow gum, plane tree gum, xanthan gum, soybean soluble polysaccharide, pectin, starch and modified starch.

In one or more embodiments, the hydrocolloid included in the melt-processable plasticized cellulose ester composition of the present invention includes both hydrophilic and hydrophobic domains. Examples of hydrocolloids with both hydrophilic and hydrophobic domains include without limitation gum arabic, Gum karaya, Tragacanth gum, Gum ghatti, Larchwood gum, fenugreek gum, Pectins such as Sugar beet pectin, Depolymerized citrus pectin, Chicory root pectin; chitosan, mesquite gum, Corn fiber gum and modified starches such as sodium octenyl succinate starch.

In one or more embodiments, the melt-processable plasticized cellulose ester compositions of the present invention may include one or more optional additives. Non-limiting examples of additives include UV absorbers, antioxidants, acid scavengers such as epoxidized soybean oil, radical scavengers, an epoxidized oil and combinations thereof filler, additive, biopolymer, stabilizer, and/or odor modifier waxes, compatibilizers, biodegradation promoters, dyes, pigments, colorants, luster control agents, lubricants, anti-oxidants, viscosity modifiers, antifungal agents, anti-fogging agents, heat stabilizers, impact modifiers, antibacterial agents, softening agents, processing aids, mold release agents, and combinations thereof. It should be noted that the same type of compounds or materials may be identified for or included in multiple categories of components in the melt-processable, plasticized cellulose ester compositions. For example, polyethylene glycol (PEG) could function as a plasticizer or as an additive that does not function as a plasticizer, such as a hydrophilic polymer or biodegradation promotor, e.g., where a lower molecular weight PEG has a plasticizing effect and a higher molecular weight PEG functions as a hydrophilic polymer but without plasticizing effect. In one or more embodiments, the melt-processable plasticized cellulose ester compositions of the present invention may include glyceryl monostearate (GMS) or other fatty acid salt or ester. The GMS or other fatty acid derivative may be added as a lubricant, release agent, or to reduce tackiness.

In embodiments, the melt-processable plasticized cellulose ester compositions comprise at least one filler. In embodiments, the filler is of a type and present in an amount to enhance biodegradability and/or compostability of an article including, prepared from or formed from the composition. In embodiments, the melt-processable plasticized cellulose ester composition comprises at least one filler chosen from: carbohydrates (sugars and salts), cellulosic and organic fillers (wood flour, wood fibers, hemp, cellulose carbon, coal particles, graphite, and starches), mineral and inorganic fillers (calcium carbonate, talc, silica, titanium dioxide, glass fibers, glass spheres, boronitride, aluminum trihydrate, magnesium hydroxide, calcium hydroxide, alumina, and clays), food wastes or byproduct (eggshells, distillers grain, and coffee grounds), dessicants (e.g. calcium sulfate, magnesium sulfate, magnesium oxide, calcium oxide), or combinations (e.g., mixtures) thereof. In embodiments, the melt-processable plasticized cellulose ester compositions include at least one filler that also functions as a colorant additive. In embodiments, the colorant additive filler may be chosen from: carbon, graphite, titanium dioxide, opacifiers, dyes, pigments, toners and combinations thereof. In embodiments, the melt-processable plasticized cellulose ester compositions include at least one filler that also functions as a stabilizer or flame retardant.

In embodiments, the melt-processable plasticized cellulose ester compositions optionally further include a biodegradable polymer (other than a cellulose ester such as cellulose acetate). In embodiments, the other biodegradable polymer may be chosen from polyhydroxyalkanoates (PHAs and PHBs), polylactic acid (PLA), polycaprolactone polymers (PCL), polybutylene adipate terephthalate (PBAT), polyethylene succinate (PES), polyvinyl acetates (PVAs), polybutylene succinate (PBS) and copolymers (such as polybutylene succinate-co-adipate (PBSA)), cellulose esters, cellulose ethers, starch, proteins, derivatives thereof, and combinations thereof. In embodiments, the melt-processable plasticized cellulose ester compositions may include two or more biodegradable polymers. In embodiments, the biodegradable polymer (other than a cellulose ester) is present in an amount from 0.1 to less than 50 wt %, or 1 to 40 wt %, or 1 to 30 wt %, or 1 to 25 wt %, or 1 to 20 wt %, based on the total weight of the melt-processable plasticized cellulose ester composition. In embodiments, the melt-processable plasticized cellulose ester compositions contain a biodegradable polymer (other than cellulose ester) in an amount from 0.1 to less than 50 wt %, or 1 to 40 wt %, or 1 to 30 wt %, or 1 to 25 wt %, or 1 to 20 wt %, based on the total amount of cellulose ester plus biodegradable polymer. In embodiments, the biodegradable polymer comprises a PHA having a weight average molecular weight (Mw) in a range from 10,000 to 1,000,000, or 50,000 to 1,000,000, or 100,000 to 1,000,000, or 250,000 to 1,000,000, or 500,000 to 1,000,000, or 600,000 to 1,000,000, or 600,000 to 900,000, or 700,000 to 800,000, or 10,000 to 500,000, or 10,000 to 250,000, or 10,000 to 100,000, or 10,000 to 50,000, measured using gel permeation chromatography (GPC) with a refractive index detector and polystyrene standards employing a solvent of methylene chloride. In embodiments, the PHA may include a polyhydroxybutyrate-co-hydroxyhexanoate.

In certain embodiments, the melt-processable plasticized cellulose ester compositions optionally comprise at least one stabilizer. Although it may be generally desirable for the melt-processable plasticized cellulose ester compositions and the articles that include or are formed from or prepared using them to be composable and/or biodegradable, a certain amount of stabilizer may be added to provide a selected shelf life or stability, e.g., towards light exposure, oxidative stability, or hydrolytic stability. In various embodiments, stabilizers may include UV absorbers, antioxidants (ascorbic acid, BHT, BHA, etc.), other acid and radical scavengers, epoxidized oils, e.g., epoxidized soybean oil, or combinations thereof.

Antioxidants (AOs) may be classified into several classes, including primary antioxidant, and secondary antioxidant. Primary antioxidants a generally known to function essentially as free radical terminators (scavengers). Secondary antioxidants are generally known to decompose hydroperoxides (ROOH) into nonreactive products before they decompose into alkoxy and hydroxy radicals. Secondary antioxidants are often used in combination with free radical scavengers (primary antioxidants) to achieve a synergistic inhibition effect and secondary AOs are used to extend the life of phenolic type primary AOs.

“Primary antioxidants” are antioxidants that act by reacting with peroxide radicals via a hydrogen transfer to quench the radicals. Primary antioxidants generally contain reactive hydroxy or amino groups such as in hindered phenols and secondary aromatic amines. Examples of primary antioxidants include BHT, Irganox™ 1010, 1076, 1726, 245, 1098, 259, and 1425; Ethanox™ 310, 376, 314, and 330; Evernox™ 10, 76, 1335, 1330, 3114, MD 1024, 1098, 1726, 120. 2246, and 565; Anox™ 20, 29, 330, 70, IC-14, and 1315; Lowinox™ 520, 1790, 221B46, 22M46, 44B25, AH25, GP45, CELLULOSE ACETATE22, CPL,3 HD98, TBM-6, and WSP; Naugard™ 431, PS48, SP, and 445; Songnox™ 1010, 1024, 1035, 1076 CP, 1135 LQ, 1290 PW, 1330FF, 1330PW, 2590 PW, and 3114 FF; and ADK Stab AO-20, AO-30, AO-40, AO-50, AO-60, AO-80, and AO-330.

“Secondary antioxidants” are often hydroperoxide decomposers. They act by reacting with hydroperoxides to decompose them into nonreactive and thermally stable products that are not radicals. They are often used in conjunction with primary antioxidants. Examples of secondary antioxidants include the organophosphorous (e.g., phosphites, phosphonites) and organosulfur classes of compounds. The phosphorous and sulfur atoms of these compounds react with peroxides to convert the peroxides into alcohols. Examples of secondary antioxidants include Ultranox 626, Ethanox™ 368, 326, and 327; Doverphos™ LPG11, LPG12, DP S-680, 4, 10, S480, S-9228, S-9228T; Evernox™ 168 and 626; Irgafos™ 126 and 168; Weston™ DPDP, DPP, EHDP, PDDP, TDP, TLP, and TPP; Mark™ CH 302, CH 55, TNPP, CH66, CH 300, CH 301, CH 302, CH 304, and CH 305; ADK Stab 2112, HP-10, PEP-8, PEP-36, 1178, 135A, 1500, 3010, C, and TPP; Weston 439, DHOP, DPDP, DPP, DPTDP, EHDP, PDDP, PNPG, PTP, PTP, TDP, TLP, TPP, 398, 399, 430, 705, 705T, TLTTP, and TNPP; Alkanox 240, 626, 626A, 627AV, 618F, and 619F; and Songnox™ 1680 FF, 1680 PW, and 6280 FF.

In embodiments, the melt-processable plasticized cellulose ester compositions comprise at least one stabilizer, wherein the stabilizer comprises one or more secondary antioxidants. In embodiments, the stabilizer comprises a first stabilizer component chosen from one or more secondary antioxidants and a second stabilizer component chosen from one or more primary antioxidants, citric acid or a combination thereof.

In embodiments, the stabilizer comprises one or more secondary antioxidants in an amount in the range of from 0.01 to 0.8, or 0.01 to 0.7, or 0.01 to 0.5, or 0.01 to 0.4, or 0.01 to 0.3, or 0.01 to 0.25, or 0.01 to 0.2, or 0.05 to 0.8, or 0.05 to 0.7, or 0.05 to 0.5, or 0.05 to 0.4, or 0.05 to 0.3, or 0.05 to 0.25, or 0.05 to 0.2, or 0.08 to 0.8, or 0.08 to 0.7, or 0.08 to 0.5, or 0.08 to 0.4, or 0.08 to 0.3, or 0.08 to 0.25, or 0.08 to 0.2, in weight percent based on the total weight of the composition. In one class of this embodiment, the stabilizer comprises a secondary antioxidant that is a phosphite compound. In one class of this embodiment, the stabilizer comprises a secondary antioxidant that is a phosphite compound and another secondary antioxidant that is DLTDP.

In one subclass of this class, the stabilizer further comprises a second stabilizer component that comprises one or more primary antioxidants in an amount in the range of from 0.05 to 0.7, or 0.05 to 0.6, or 0.05 to 0.5, or 0.05 to 0.4, or 0.05 to 0.3, or 0.1 to 0.6, or 0.1 to 0.5, or 0.1 to 0.4, or 0.1 to 0.3, in weight percent of the total amount of primary antioxidants based on the total weight of the composition. In one subclass of this class, the stabilizer further comprises a second stabilizer component that comprises citric acid in an amount in the range of from 0.05 to 0.2, or 0.05 to 0.15, or 0.05 to 0.1 in weight percent of the total amount of citric acid based on the total weight of the composition. In one subclass of this class, the stabilizer further comprises a second stabilizer component that comprises one or more primary antioxidants and citric acid in the amounts discussed herein. In one subclass of this class, the stabilizer comprises less than 0.1 wt % or no primary antioxidants, based on the total weight of the composition. In one subclass of this class, the stabilizer comprises less than 0.05 wt % or no primary antioxidants, based on the total weight of the composition.

In embodiments, depending on the application, e.g., single use food contact applications, the melt-processable plasticized cellulose ester compositions may include at least one odor modifying additive. In embodiments, depending on the application and components used in the melt-processable plasticized cellulose ester compositions, suitable odor modifying additives may be chosen from: vanillin, Pennyroyal M-1178, almond, cinnamyl, spices, spice extracts, volatile organic compounds or small molecules, and Plastidor. In one embodiment, the odor modifying additive may be vanillin. In embodiments, the melt-processable plasticized cellulose ester compositions may include an odor modifying additive in an amount from 0.01 to 1 wt %, or 0.1 to 0.5 wt %, or 0.1 to 0.25 wt %, or 0.1 to 0.2 wt %, based on the total weight of the composition. Mechanisms for the odor modifying additives may include masking, capturing, complementing or combinations of these.

As discussed above, melt-processable plasticized cellulose ester compositions may include other optional additives. In embodiments, the melt-processable plasticized cellulose ester compositions may include at least one compatibilizer. In embodiments, the compatibilizer may be either a nonreactive compatibilizer or a reactive compatibilizer. The compatibilizer may enhance the ability of the cellulose ester or another component to reach a desired small particle size to improve the dispersion of the chosen component in the composition. In such embodiments, depending on the desired formulation, the cellulose ester may either be in the continuous or discontinuous phase of the dispersion. In embodiments, the compatibilizers used may improve mechanical and/or physical properties of the compositions by modifying the interfacial interaction/bonding between the cellulose ester and another component, e.g., other biodegradable polymer.

In embodiments, the melt-processable plasticized cellulose ester compositions comprise a compatibilizer in an amount from about 1 to about 40 wt %, or about 1 to about 30 wt %, or about 1 to about 20 wt %, or about 1 to about 10 wt %, or about 5 to about 20 wt %, or about 5 to about 10 wt %, or about 10 to about 30 wt %, or about 10 to about 20 wt %, based on the weight of the melt-processable, plasticized cellulose ester composition.

In embodiments, if desired, the melt-processable plasticized cellulose ester compositions may include biodegradation and/or decomposition agents, e.g., hydrolysis assistant or any intentional degradation promoter additives may be added to or contained in the composition, added either during manufacture of the cellulose acetate or subsequent to its manufacture and melt or solvent blended together with the cellulose acetate to promote biodegradability of the melt-processable, plasticized cellulose ester composition and/or compostability and/or disintegratability of articles including or formed from or prepared using it. In embodiments, additives may promote hydrolysis by releasing acidic or basic residues, and/or accelerate photo (UV) or oxidative degradation and/or promote the growth of selective microbial colony to aid the disintegration and biodegradation in compost and soil medium. In addition to promoting the degradation, these additives may have an additional function such as improving the processability of the article or improving desired article mechanical properties.

One set of examples of possible decomposition agents include inorganic carbonate, synthetic carbonate, nepheline syenite, talc, magnesium hydroxide, aluminum hydroxide, diatomaceous earth, natural or synthetic silica, calcined clay, and the like. In embodiments, it may be desirable that these additives are dispersed well in the composition matrix. The additives may be used singly, or in a combination of two or more.

Another set of examples of possible decomposition agents are aromatic ketones used as an oxidative decomposition agent, including benzophenone, anthraquinone, anthrone, acetylbenzophenone, 4-octylbenzophenone, and the like. These aromatic ketones may be used singly, or in a combination of two or more.

Other examples include transition metal compounds used as oxidative decomposition agents, such as salts of cobalt or magnesium, e.g., aliphatic carboxylic acid (C12 to C20) salts of cobalt or magnesium, or cobalt stearate, cobalt oleate, magnesium stearate, and magnesium oleate; or anatase-form titanium dioxide, or titanium dioxide may be used. Mixed phase titanium dioxide particles may be used in which both rutile and anatase crystalline structures are present in the same particle. The particles of photoactive agent may have a relatively high surface area, for example from about 10 to about 300 sq. m/g, or from 20 to 200 sq. m/g, as measured by the BET surface area method. The photoactive agent may be added to the plasticizer if desired. These transition metal compounds may used singly, or in a combination of two or more.

Examples of rare earth compounds that may be used as oxidative decomposition agents include rare earths belonging to periodic table Group 3A, and oxides thereof. Specific examples thereof include cerium (Ce), yttrium (Y), neodymium (Nd), rare earth oxides, hydroxides, rare earth sulfates, rare earth nitrates, rare earth acetates, rare earth chlorides, rare earth carboxylates, and the like. More specific examples thereof include cerium oxide, ceric sulfate, ceric ammonium Sulfate, ceric ammonium nitrate, cerium acetate, lanthanum nitrate, cerium chloride, cerium nitrate, cerium hydroxide, cerium octylate, lanthanum oxide, yttrium oxide, scandium oxide, and the like. These rare earth compounds may be used singly, or in a combination of two or more.

In one or more embodiments, the melt-processable plasticized cellulose ester compositions include an additive with pro-degradant functionality to enhance biodegradability that comprises a transition metal salt or chemical catalyst, containing transition metals such as cobalt, manganese and iron. Suitable transition metal salts include tartrates, stearates, oleates, citrates and chlorides. The additives further may further include a free radical scavenging system and one or more inorganic or organic fillers such as chalk, talc, silica, wollastonite, starch, cotton, reclaimed cardboard and plant matter. The additive may also comprise an enzyme, a bacterial culture, a swelling agent, CMC, sugar or other energy sources. The additives may also comprise hydroxylamine esters and thio compounds.

In certain embodiments, other possible biodegradation and/or decomposition agents may include swelling agents and disintegrants. Swelling agents may be hydrophilic materials that increase in volume after absorbing water and exert pressure on the surrounding matrix. Disintegrants may be additives that promote the breakup of a matrix into smaller fragments in an aqueous environment. Examples include minerals and polymers, including crosslinked or modified polymers and swellable hydrogels. In embodiments, the composition may include water-swellable minerals or clays and their salts, such as laponite and bentonite; hydrophilic polymers, such as poly(acrylic acid) and salts, poly(acrylamide), poly(ethylene glycol) and poly(vinyl alcohol); polyglycolic acid; polysaccharides such as starch, psyllium, and modified polymers, such as crosslinked PVP, sodium starch glycolate, carboxymethyl cellulose, gelatinized starch, croscarmellose sodium; or combinations of these additives.

In embodiments, the melt-processable plasticized cellulose ester compositions may include a pH-basic additive that can increase decomposition or degradation of the composition or article including, made from or prepared using the melt-processable plasticized cellulose ester composition. Examples of pH-basic additives that may be used as oxidative decomposition agents include alkaline earth metal oxides, alkaline earth metal hydroxides, alkaline earth metal carbonates, alkali metal carbonates, alkali metal bicarbonates, ZnO and basic Al₂O₃. In embodiments, at least one basic additive may be MgO, Mg(OH)₂, MgCO₃, CaO, Ca(OH)₂, CaCO₃, NaHCO₃, Na₂CO₃, K₂CO₃, ZnO KHCO₃ or basic Al₂O₃. In one aspect, alkaline earth metal oxides, ZnO and basic Al₂O₃ may be used as a basic additive. In embodiments, combinations of different pH-basic additives, or pH-basic additives with other additives, may be used. In embodiments, the pH-basic additive has a pH in the range from greater than 7.0 to 10.0, or 7.1 to 9.5, or 7.1 to 9.0, or 7.1 to 8.5, or 7.1 to 8.0, measured in a 1 wt % mixture/solution of water.

Examples of organic acid additives that may be used as oxidative decomposition agents include acetic acid, propionic acid, butyric acid, valeric acid, citric acid, tartaric acid, oxalic acid, malic acid, benzoic acid, formate, acetate, propionate, butyrate, valerate citrate, tartarate, oxalate, malate, maleic acid, maleate, phthalic acid, phthalate, benzoate, and combinations thereof.

Examples of other hydrophilic polymers or biodegradation promoters may include glycols, polyglycols, polyethers, and polyalcohols or other biodegradable polymers such as poly(glycolic acid), poly(lactic acid), polyethylene glycol, polypropylene glycol, polydioxanes, polyoxalates, poly(α-esters), polycarbonates, polyanhydrides, polyacetals, polycaprolactones, poly(orthoesters), polyamino acids, aliphatic polyesters such as poly(butylene)succinate, poly(ethylene)succinate, starch, regenerated cellulose, or aliphatic-aromatic polyesters such as PBAT.

In embodiments, examples of colorants may include carbon black, iron oxides such as red or blue iron oxides, titanium dioxide, silicon dioxide, cadmium red, calcium carbonate, kaolin clay, aluminum hydroxide, barium sulfate, zinc oxide, aluminum oxide, and organic pigments such as azo and diazo and triazo pigments, condensed azo, azo lakes, naphthol pigments, anthrapyrimidine, benzimidazolone, carbazole, diketopyrrolopyrrole, flavanthrone, indigoid pigments, isoindolinone, isoindoline, isoviolanthrone, metal complex pigments, oxazine, perylene, perinone, pyranthrone, pyrazoloquinazolone, quinophthalone, triaryl carbonium pigments, triphendioxazine, xanthene, thioindigo, indanthrone, isoindanthrone, anthanthrone, anthraquinone, isodibenzanthrone, triphendioxazine, quinacridone and phthalocyanine series, especially copper phthalocyanme and its nuclear halogenated derivatives, and also lakes of acid, basic and mordant dyes, and isoindolinone pigments, as well as plant and vegetable dyes, and any other available colorant or dye.

In embodiments, luster control agents for adjusting the glossiness and fillers may include silica, talc, clay, barium sulfate, barium carbonate, calcium sulfate, calcium carbonate, magnesium carbonate, and the like.

Suitable flame retardants may include silica, metal oxides, phosphates, catechol phosphates, resorcinol phosphates, borates, inorganic hydrates, and aromatic polyhalides.

Although it is desirable for articles including, formed from or prepared using melt-processable plasticized cellulose ester composition to be compostable, disintegratable and/or biodegradable, a certain amount of antifungal, antimicrobial or antibacterial agents may be added to provide a selected shelf life, useful service life or stability. Such agents include without limitation polyene antifungals (e.g., natamycin, rimocidin, filipin, nystatin, amphotericin B, cadicin, and hamycin), imidazole antifungals such as miconazole (available as MICELLULOSE ACETATETIN® from WellSpring Pharmaceutical Corporation), ketoconazole (commercially available as NIZORAL® from McNeil consumer Healthcare), clotrimazole (commercially available as LOTRAMIN® and LOTRAMIN AF® available from Merck and CASTEN® available from Bayer), econazole, omoconazole, bifonazole, butoconazole, fenticonazole, isoconazole, oxiconazole, sertaconazole (commercially available as ERTACZOO from OrthoDematologics), sulconazole, and tioconazole; triazole antifungals such as fluconazole, itraconazole, isavuconazole, ravuconazole, posaconazole, voriconazole, terconazole, and albaconazole), thiazole antifungals (e.g., abafungin), allylamine antifungals (e.g., terbinafine (commercially available as LAMISIL® from Novartis Consumer Health, Inc.), naftifine (commercially available as NAFTIN® available from Merz Pharmaceuticals), and butenafine (commercially available as LOTRAMIN ULTRA® from Merck), echinocadin antifungals (e.g., anidulafungin, capofungin, and micafungin), polygodial, benzoic acid, ciclopirox, tolnaftate (e.g., commercially available as TINACTIN® from MDS Consumer Care, Inc.), undecylenic acid, flucytosine, 5-fluorocytosine, griseofulvin, haloprogin, caprylic acid, and any combination thereof.

Viscosity modifiers having the purpose of modifying the melt flow index or viscosity of the melt-processable plasticized cellulose ester compositions that may be used include polyethylene glycols and polypropylene glycols, and glycerin.

In embodiments, other components that may be included in the composition may function as release agents or lubricants (e.g. fatty acids, ethylene glycol distearate), anti-block or slip agents (e.g. one or more fatty acid esters, metal stearate salts (for example, zinc stearate), and waxes), antifogging agents (e.g. surfactants), thermal stabilizers (e.g. epoxy stabilizers, derivatives of epoxidized soybean oil (ESBO), linseed oil, and sunflower oil), anti-static agents, foaming agents, biocides, impact modifiers, or reinforcing fibers. More than one component may be present in the composition. It should be noted that an additional component may serve more than one function in the composition. The different (or specific) functionality of any particular additive (or component) to the composition can be dependent on its physical properties (e.g., molecular weight, solubility, melt temperature, Tg, etc.) and/or the amount of such additive/component in the overall composition. For example, polyethylene glycol can function as a plasticizer at one molecular weight or as a hydrophilic agent (with little or no plasticizing effect) at another molecular weight.

In embodiments, fragrances may be added if desired. Examples of fragrances include spices, spice extracts, herb extracts, essential oils, smelling salts, volatile organic compounds, volatile small molecules, methyl formate, methyl acetate, methyl butyrate, ethyl acetate, ethyl butyrate, isoamyl acetate, pentyl butyrate, pentyl pentanoate, octyl acetate, myrcene, geraniol, nerol, citral, citronellal, citronellol, linalool, nerolidol, limonene, camphor, terpineol, alpha-ionone, thujone, benzaldehyde, eugenol, isoeugenol, cinnamaldehyde, ethyl maltol, vanilla, vanillin, cinnamyl alcohol, anisole, anethole, estragole, thymol, furaneol, methanol, rosemary, lavender, citrus, freesia, apricot blossoms, greens, peach, jasmine, rosewood, pine, thyme, oakmoss, musk, vetiver, myrrh, blackcurrant, bergamot, grapefruit, acacia, passiflora, sandalwood, tonka bean, mandarin, neroli, violet leaves, gardenia, red fruits, ylang-ylang, acacia farnesiana, mimosa, tonka bean, woods, ambergris, daffodil, hyacinth, narcissus, black currant bud, iris, raspberry, lily of the valley, sandalwood, vetiver, cedarwood, neroli, strawberry, carnation, oregano, honey, civet, heliotrope, caramel, coumarin, patchouli, dewberry, helonial, coriander, pimento berry, labdanum, cassie, aldehydes, orchid, amber, orris, tuberose, palmarosa, cinnamon, nutmeg, moss, styrax, pineapple, foxglove, tulip, wisteria, clematis, ambergris, gums, resins, civet, plum, castoreum, civet, myrrh, geranium, rose violet, jonquil, spicy carnation, galbanum, petitgrain, iris, honeysuckle, pepper, raspberry, benzoin, mango, coconut, hesperides, castoreum, osmanthus, mousse de chene, nectarine, mint, anise, cinnamon, orris, apricot, plumeria, marigold, rose otto, narcissus, tolu balsam, frankincense, amber, orange blossom, bourbon vetiver, opopanax, white musk, papaya, sugar candy, jackfruit, honeydew, lotus blossom, muguet, mulberry, absinthe, ginger, juniper berries, spicebush, peony, violet, lemon, lime, hibiscus, white rum, basil, lavender, balsamics, fo-ti-tieng, osmanthus, karo karunde, white orchid, calla lilies, white rose, rhubrum lily, tagetes, ambergris, ivy, grass, seringa, spearmint, clary sage, cottonwood, grapes, brimbelle, lotus, cyclamen, orchid, glycine, tiare flower, ginger lily, green osmanthus, passion flower, blue rose, bay rum, cassia, Africa tagetes, Anatolian rose, Auvergne narcissus, British broom, British broom chocolate, Bulgarian rose, Chinese patchouli, Chinese gardenia, Calabrian mandarin, Comoros Island tuberose, Ceylonese cardamom, Caribbean passion fruit, Damascena rose, Georgia peach, white Madonna lily, Egyptian jasmine, Egyptian marigold, Ethiopian civet, Farnesian cassie, Florentine iris, French jasmine, French jonquil, French hyacinth, Guinea oranges, Guyana capua, Grasse petitgrain, Grasse rose, Grasse tuberose, Haitian vetiver, Hawaiian pineapple, Israeli basil, Indian sandalwood, Indian Ocean vanilla, Italian bergamot, Italian iris, Jamaica pepper, May rose, Madagascar ylang-ylang, Madagascar vanilla, Moroccan jasmine, Moroccan rose, Moroccan oakmoss, Moroccan orange blossom, Mysore sandalwood, Oriental rose, Russian leather, Russian coriander, Sicilian mandarin, South African marigold, South America tonka bean, Singapore patchouli, Spanish orange blossom, Sicilian lime, Reunion Island vetiver, Turkish rose, Thai benzoin, Tunisian orange blossom, Yugoslavian oakmoss, Virginian cedarwood, Utah yarrow, West Indian rosewood, and the like, and any combination thereof.

As described herein, the melt-processable plasticized cellulose ester composition of the present invention is melt-processable and may be useful in forming melt-formed articles. Accordingly, in another aspect, the present invention is directed to a melt-processable cellulose acetate melt. The term “melt” is utilized to generally describe a flowable, liquid form of the composition, sometimes viscous in nature, typically created by raising the composition to a temperature sufficient to facilitate molten flow (in contrast for example to addition of a solvent to form a dispersion, suspension or solution). A melt is typically the form necessary for melt-processing to produce a melt-formed article. In describing a composition herein as “melt-processable”, is intended to include compositions which are capable of forming a melt that is processable into useful melt-formed articles using melt processes such as extrusion, including without limitation profile extrusion and sheet extrusion; injection molding; compression molding; blow molding; melt spinning; thermoforming; and the like. Accordingly, in one or more embodiments, the present invention is directed to a cellulose ester melt, useful in particular for forming melt-formed articles. In one or more embodiments, the cellulose ester melt includes, is prepared from or is formed from the melt-processable plasticized cellulose ester composition of the present invention. In one or more embodiments, the cellulose ester melt includes (i) cellulose ester; (ii) plasticizer; and (iii) a hydrocolloid.

An important general feature of the melt-processable compositions and melts of the present invention is the unexpected improvement in processability in the manufacture of melt-formed articles. One parameter that demonstrates this feature may be melt viscosity. Melt Viscosity measures the rate of extrusion of thermoplastics through an orifice at a prescribed temperature and load and is an important indicator of equipment power consumption, torque and pressure during melt processing. Melt viscosity provides a means of measuring flow of a melted material which can be used to evaluate the consistency and processability of materials. Representative methods to evaluate processability include melt flow rate (MFR), melt volume-flow rate (MVR), a method using a measuring instrument such as a capillary rheometer, melt rheology, melt flow index (MFI; described in standards ASTM D1238 and ISO1133, bar flow evaluation using an injection molding machine. Viscosity is measured according to ASTM D-4440. Formulations described in this invention have a melt viscosity between 3000 poise to as much as 500,000 poise when measured at 230 C and a shear rate of 1 rad/sec. Processing temperatures can be altered to yield desired flow behavior based on the target application.

In one embodiment or in combination with any other embodiment, the melt-processable plasticized cellulose ester composition of the present application exhibits a degree of strain hardening (“SH”) that is in the range of 10% to 100%, or 20% to 100%, or 30% to 100%, or 40% to 100%, or 50% to 100%, or 60% to 100%, or 60% to 80%, or 50% to 80%, or 40% to 80%, or 40% to 60%, or 30% to 80%, or 30% to 60%, or 30% to 40%, or 20% to 80%, or 20% to 60%, or 20% to 40%, or 10% to 80%, or 10% to 60%, or 10% to 40%, or 10% to 20% than the melt-processable cellulose ester composition without a hydrocolloid, wherein the SH is determined according to the procedure disclosed herein (i.e., Example 9).

In one embodiment or in combination with any other embodiment, the melt-processable plasticized cellulose ester composition of the present application exhibits a maximum areal draw ratio (“Max ADR”) that is in the range of 10% to 50%, or 20% to 50%, or 30% to 50%, or 40% to 50%, or 30% to 40%, or 20% to 40%, or 20% to 30%, or 10% to 40%, or 10% to 30%, or 10% to 20% than the melt-processable cellulose ester composition without a hydrocolloid, wherein the Max ADR is determined according to the procedure disclosed herein (i.e., Example 8).

In one or more embodiments, the melt-processable plasticized cellulose acetate composition of the present invention is a foamable composition. In one or more embodiments, the melt processable, plasticized foamable composition of the present invention includes (i) cellulose acetate; (ii) plasticizer; (iii) a hydrocolloid; (iv) optionally, at least one nucleating agent; and (v) at least one blowing agent selected from the group consisting of a physical blowing agent, a chemical blowing composition comprising a chemical blowing agent and carrier polymer and combinations thereof.

In another aspect, the present invention is directed to an article. In one or more embodiments, the article is a melt-formed article. The article of the present invention includes, is formed from or is prepared using a melt-processable plasticized cellulose ester composition that includes cellulose ester, plasticizer and a hydrocolloid. In one or more embodiments, the articles may be melt-formed articles such as for example extruded articles such as profile extruded articles and sheet extruded articles; injection molded articles; compression molded articles; thermoformed articles; melt-spun articles such as melt-spun fibers; and the like. In one or more embodiments, the melt-formed articles of the present invention may be molded single use food contact articles, including articles that are biodegradable and/or compostable (i.e., either industrial or home compostability tests/criterial as discussed herein). In embodiments, the melt-processable, plasticized cellulose ester compositions may be extrudable, moldable, castable, thermoformable, or may be 3-D printed. “Articles” as used herein is defined to include articles in their entirety as well as components, elements or parts of articles that may be connected, adhered, assembled or the like. In embodiments, the articles are environmentally non-persistent. “Environmentally non-persistent” is meant to describe materials or articles that, upon reaching an advanced level of disintegration, become amenable to total consumption by the natural microbial population. The degradation of biodegradable cellulose acetate ultimately leads its conversion to carbon dioxide, water and biomass.

In embodiments, articles comprising the melt-processable, plasticized cellulose ester compositions (discussed herein) are provided that have a maximum thickness up to 150 mils, or 140 mils, or 130 mils, or 120 mils, or 110 mils, or 100 mils, or 90 mils, or 80 mils, or 70 mils, or 60 mils, or 50 mils, or 40 mils, or 30 mils, or 25 mils, or 20 mils, or 15 mils, or 10 mils, and may be biodegradable and/or compostable. In embodiments, articles comprising the melt-processable, plasticized cellulose ester compositions (discussed herein) are provided that have a maximum thickness up to 150 mils, or 140 mils, or 130 mils, or 120 mils, or 110 mils, to 100 mils, or 90 mils, or 80 mils, or 70 mils, or 60 mils, or 50 mils, or 40 mils, or 30 mils, or 25 mils, or 20 mils, or 15 mils, or 10 mils, and may be environmentally non-persistent.

In embodiments, the melt-processable plasticized cellulose ester composition of the present invention, as well as the melt and the melt-formed article, may include recycle content. In one or more embodiments, the recycle content includes biodegradable cellulose ester regrind. The term “regrind” is intended to include material sourced from reclaimed, scrap, in-house scrap such as scrap from molders, off-spec or post-industrial sources that has been ground, milled, crushed, pulverized or the like to a particle- or powder-like form.

In one or more embodiments, the recycle content is provided by a reactant derived from recycled material that is the source of one or more acetyl groups on a recycle cellulose acetate. In embodiments, the reactant is derived from recycled plastic. In embodiments, the reactant is derived from recycled plastic content syngas. By “recycled plastic content syngas” is meant syngas obtained from a synthesis gas operation utilizing a feedstock that contains at least some content of recycled plastics, as described in the various embodiments more fully herein below. In embodiments, the recycled plastic content syngas may be made in accordance with any of the processes for producing syngas described herein; may comprise, or consist of, any of the syngas compositions or syngas composition streams described herein; or cellulose ester be made from any of the feedstock compositions described herein.

In embodiments, the feedstock (for the synthesis gas operation) may be in the form of a combination of one or more particulated fossil fuel sources and particulated recycled plastics. In one embodiment or in any of the mentioned embodiments, the solid fossil fuel source may include coal. In embodiments, the feedstock is fed to a gasifier along with an oxidizer gas, and the feedstock is converted to syngas.

In embodiments, the recycled plastic content syngas is utilized to make at least one chemical intermediate in a reaction scheme to make a recycle cellulose ester. In embodiments, the recycled plastic content syngas may be a component of feedstock (used to make at least one cellulose acetate intermediate or reactant that includes other sources of syngas, hydrogen, carbon monoxide, or combinations thereof. In one embodiment or in any of the mentioned embodiments, the only source of syngas used to make the cellulose acetate intermediates is the recycled plastic content syngas.

In embodiments, the cellulose ester intermediates made using the recycled content syngas, e.g., recycled plastic content syngas, may be chosen from methanol, acetic acid, methyl acetate, acetic anhydride and combinations thereof. In embodiments, the cellulose ester intermediates may be a at least one reactant or at least one product in one or more of the following reactions: (1) syngas conversion to methanol; (2) syngas conversion to acetic acid; (3) methanol conversion to acetic acid, e.g., carbonylation of methanol to produce acetic acid; (4) producing methyl acetate from methanol and acetic acid; and (5) conversion of methyl acetate to acetic anhydride, e.g., carbonylation of methyl acetate and methanol to acetic acid and acetic anhydride.

In embodiments, recycled plastic content syngas is used to produce at least one cellulose reactant. In embodiments, the recycled plastic content syngas is used to produce at least one recycle cellulose ester.

In embodiments, the recycled plastic content syngas is utilized to make acetic anhydride. In embodiments, syngas that comprises recycled plastic content syngas is first converted to methanol and this methanol is then used in a reaction scheme to make acetic anhydride. “RPS acetic anhydride” refers to acetic anhydride that is derived from recycled plastic content syngas. Derived from means that at least some of the feedstock source material (that is used in any reaction scheme to make a cellulose ester intermediate) has some content of recycled plastic content syngas.

In embodiments, the RPS acetic anhydride is utilized as a cellulose acetate intermediate reactant for the esterification of cellulose to prepare a recycle cellulose acetate, as discussed more fully above. In embodiments, the RPS acetic acid is utilized as a reactant to prepare cellulose acetate or cellulose diacetate.

In embodiments, the recycle cellulose ester prepared from a cellulose reactant that comprises acetic anhydride that is derived from recycled plastic content syngas.

In embodiments, the recycled plastic content syngas comprises gasification products from a gasification feedstock. In an embodiment, the gasification products are produced by a gasification process using a gasification feedstock that comprises recycled plastics. In embodiments, the gasification feedstock comprises coal.

In embodiments, the gasification feedstock comprises a liquid slurry that comprises coal and recycled plastics. In embodiments, the gasification process comprises gasifying said gasification feedstock in the presence of oxygen.

In one or more embodiments, the melt-processable cellulose acetate composition includes at least one cellulose ester having at least one substituent on an anhydroglucose unit (AGU) derived from one or more chemical intermediates, at least one of which is obtained at least in part from recycled plastic content syngas.

In embodiments, the cellulose ester of the melt-processable plasticized cellulose ester composition includes cellulose ester derived from a renewable source, e.g., cellulose from wood or cotton linter, and cellulose acetate derived from a recycled material source, e.g., recycled plastics or recycle syngas. Thus, in embodiments, a melt processible plasticized cellulose acetate composition is provided that is biodegradable and contains both renewable and recycled content, i.e., made from renewable and recycled sources.

In embodiments, the composition, melt and/or the melt-formed article of the present invention may have a certain degree of degradation or degradability. The degree of degradation may be characterized by the weight loss of a sample over a given period of exposure to certain environmental conditions. In some cellulose esters, the cellulose ester exhibits a weight loss of at least about 5, 10, 15, or 20 percent after burial in soil for 60 days and/or a weight loss of at least about 15, 20, 25, 30, or 35 percent after 15 days of exposure to a typical municipal composter. However, the rate of degradation may vary depending on the particular end use. Exemplary degree of degradation test conditions are provided in U.S. Pat. Nos. 5,970,988 and 6,571,802, the contents and disclosure of which are hereby incorporated herein by reference.

In some embodiments, the melt-processable plasticized cellulose ester composition may be a component of, or used in preparing or forming, biodegradable single use melt-formed articles. It has been found that melt-processable cellulose ester compositions as described herein may exhibit enhanced levels of environmental non-persistence, characterized by better-than-expected degradation under various environmental conditions. Melt-formed articles described herein may meet or exceed one or more passing standards set by international test methods and authorities for industrial compostability, home compostability, marine biodegradability and/or soil biodegradability.

To be considered “compostable,” a material must meet the following four criteria: (1) the material should pass biodegradation requirement in a test under controlled composting conditions at elevated temperature (58° C.) according to ISO 14855-1 (2012) which correspond to an absolute 90% biodegradation or a relative 90% to a control polymer, (2) the material tested under aerobic composting condition according to ISO 16929 (2013) must reach a 90% disintegration; (3) the test material must fulfill all the requirements on volatile solids, heavy metals and fluorine as stipulated by ASTM D6400 (2012), EN 13432 (2000) and ISO 17088 (2012); and (4) the material should not negatively impact plant growth. As used herein, the term “biodegradable” generally refers to the biological conversion and consumption of organic molecules. Biodegradability is an intrinsic property of the material itself, and the material may exhibit different degrees of biodegradability, depending on the specific conditions to which it is exposed. The term “disintegrable” or phrase “degree of disintegration” refers to the tendency of a material to physically decompose into smaller fragments when exposed to certain conditions. Disintegration depends both on the material itself, as well as the physical size and configuration of the article being tested. Ecotoxicity measures the impact of the material on plant life, and the heavy metal content of the material is determined according to the procedures laid out in the standard test method.

In one or more embodiments, the melt-processable plasticized cellulose ester composition, the melt and/or the melt-formed article of the present invention may be biodegradable. In one or more embodiments, the melt of the present invention may be biodegradable.

The melt-processable cellulose ester composition (or melt or melt-formed article) may exhibit a biodegradation of at least 70 percent in a period of not more than 50 days, when tested under aerobic composting conditions at ambient temperature (28° C.±2° C.) according to ISO 14855-1 (2012). In some cases, the (or article including or formed therefrom) may exhibit a biodegradation of at least 70 percent in a period of not more than 49, 48, 47, 46, 45, 44, 43, 42, 41, 40, 39, 38, or 37 days when tested under these conditions, also called “home composting conditions.” These conditions may not be aqueous or anaerobic. In some cellulose acetates, the melt-processable, plasticized cellulose ester composition (or melt or melt-formed article) may exhibit a total biodegradation of at least about 71, 72, 73, 74, 75, 76, 77, 78, 79, 80, 81, 82, 83, 84, 85, 86, 87, or 88 percent, when tested under according to ISO 14855-1 (2012) for a period of 50 days under home composting conditions. This may represent a relative biodegradation of at least about 95, 97, 99, 100, 101, 102, or 103 percent, when compared to cellulose subjected to identical test conditions.

To be considered “biodegradable,” under home composting conditions according to the French norm NF T 51-800 and the Australian standard AS 5810, a material must exhibit a biodegradation of at least 90 percent in total (e.g., as compared to the initial sample), or a biodegradation of at least 90 percent of the maximum degradation of a suitable reference material after a plateau has been reached for both the reference and test item. The maximum test duration for biodegradation under home compositing conditions is 1 year. The melt-processable, plasticized cellulose ester composition as described herein may exhibit a biodegradation of at least 90 percent within not more than 1 year, measured according 14855-1 (2012) under home composting conditions. In some cellulose acetates, the melt-processable, plasticized cellulose ester composition (or melt or melt-formed article) may exhibit a biodegradation of at least about 91, 92, 93, 94, 95, 96, 97, 98, 99, or 99.5 percent within not more than 1 year, or cellulose acetate composition (or melt or melt-formed article) may exhibit 100 percent biodegradation within not more than 1 year, measured according 14855-1 (2012) under home composting conditions.

Additionally, or in the alternative, the melt-processable, plasticized cellulose ester composition (or melt or melt-formed article) described herein may exhibit a biodegradation of at least 90 percent within not more than about 350, 325, 300, 275, 250, 225, 220, 210, 200, 190, 180, 170, 160, 150, 140, 130, 120, 110, 100, 90, 80, 70, 60, or 50 days, measured according 14855-1 (2012) under home composting conditions. In some embodiments, the composition (or melt or melt-formed article) may be at least about 97, 98, 99, or 99.5 percent biodegradable within not more than about 70, 65, 60, or 50 days of testing according to ISO 14855-1 (2012) under home composting conditions. As a result, the composition (or article including or formed therefrom) may be considered biodegradable according to, for example, French Standard NF T 51-800 and Australian Standard AS 5810 when tested under home composting conditions.

The melt-processable, plasticized cellulose ester composition (or melt or melt-formed article) may exhibit a biodegradation of at least 60 percent in a period of not more than 45 days, when tested under aerobic composting conditions at a temperature of 58° C. (±2° C.) according to ISO 14855-1 (2012). In some cases, the melt-processable, plasticized cellulose ester composition (or melt or melt-formed article) may exhibit a biodegradation of at least 60 percent in a period of not more than 44, 43, 42, 41, 40, 39, 38, 37, 36, 35, 34, 33, 32, 31, 30, 29, 28, or 27 days when tested under these conditions, also called “industrial composting conditions.” These may not be aqueous or anaerobic conditions. In some cases, the melt-processable, plasticized cellulose ester composition (or melt or melt-formed article) may exhibit a total biodegradation of at least about 65, 70, 75, 80, 85, 87, 88, 89, 90, 91, 92, 93, 94, or 95 percent, when tested under according to ISO 14855-1 (2012) for a period of 45 days under industrial composting conditions. This may represent a relative biodegradation of at least about 95, 97, 99, 100, 102, 105, 107, 110, 112, 115, 117, or 119 percent, when compared to the same cellulose acetate composition (or melt or melt-formed article) subjected to identical test conditions.

To be considered “biodegradable,” under industrial composting conditions according to ASTM D6400 and ISO 17088, at least 90 percent of the organic carbon in the whole item (or for each constituent present in an amount of more than 1% by dry mass) must be converted to carbon dioxide by the end of the test period when compared to the control or in absolute. According to European standard ED 13432 (2000), a material must exhibit a biodegradation of at least 90 percent in total, or a biodegradation of at least 90 percent of the maximum degradation of a suitable reference material after a plateau has been reached for both the reference and test item. The maximum test duration for biodegradability under industrial compositing conditions is 180 days. The melt-processable, plasticized cellulose ester composition (or melt or melt-formed article) described herein may exhibit a biodegradation of at least 90 percent within not more than 180 days, measured according 14855-1 (2012) under industrial composting conditions. In some cases, the melt-processable, plasticized cellulose ester composition (or melt or melt-formed article) may exhibit a biodegradation of at least about 91, 92, 93, 94, 95, 96, 97, 98, 99, or 99.5 percent within not more than 180 days, or cellulose acetate composition (or melt or melt-formed article) may exhibit 100 percent biodegradation within not more than 180 days, measured according 14855-1 (2012) under industrial composting conditions.

Additionally, or in the alternative, the melt-processable, plasticized cellulose ester composition (or melt or melt-formed article) described herein may exhibit a biodegradation of least 90 percent within not more than about 175, 170, 165, 160, 155, 150, 145, 140, 135, 130, 125, 120, 115, 110, 105, 100, 95, 90, 85, 80, 75, 70, 65, 60, 55, 50, or 45 days, measured according 14855-1 (2012) under industrial composting conditions. In some cases, the melt-processable, plasticized cellulose ester composition (or melt or melt-formed article) may be at least about 97, 98, 99, or 99.5 percent biodegradable within not more than about 65, 60, 55, 50, or 45 days of testing according to ISO 14855-1 (2012) under industrial composting conditions. As a result, the melt-processable, plasticized cellulose ester composition (or melt or melt-formed article) described herein may be considered biodegradable according to ASTM D6400 and ISO 17088 when tested under industrial composting conditions.

The melt-processable, plasticized cellulose ester composition (or melt or melt-formed article) may exhibit a biodegradation in soil of at least 60 percent within not more than 130 days, measured according to ISO 17556 (2012) under aerobic conditions at ambient temperature. In some cases, the composition (or melt or melt-formed article) may exhibit a biodegradation of at least 60 percent in a period of not more than 130, 120, 110, 100, 90, 80, or 75 days when tested under these conditions, also called “soil composting conditions.” These may not be aqueous or anaerobic conditions. In some cases, the composition (or melt or melt-formed article) may exhibit a total biodegradation of at least about 65, 70, 72, 75, 77, 80, 82, or 85 percent, when tested under according to ISO 17556 (2012) for a period of 195 days under soil composting conditions. This may represent a relative biodegradation of at least about 70, 75, 80, 85, 90, or 95 percent, when compared to the same composition (or melt or melt-formed article) subjected to identical test conditions.

In order to be considered “biodegradable,” under soil composting conditions according the OK biodegradable SOIL conformity mark of Vingotte and the DIN Geprüft Biodegradable in soil certification scheme of DIN CERTCO, a material must exhibit a biodegradation of at least 90 percent in total (e.g., as compared to the initial sample), or a biodegradation of at least 90 percent of the maximum degradation of a suitable reference material after a plateau has been reached for both the reference and test item. The maximum test duration for biodegradability under soil compositing conditions is 2 years. The melt-processable, plasticized cellulose ester composition (or article including or formed therefrom) as described herein may exhibit a biodegradation of at least 90 percent within not more than 2 years, 1.75 years, 1 year, 9 months, or 6 months measured according to ISO 17556 (2012) under soil composting conditions. In some cases, the composition (or melt or melt-formed article) may exhibit a biodegradation of at least about 91, 92, 93, 94, 95, 96, 97, 98, 99, or 99.5 percent within not more than 2 years, or composition (or melt or melt-formed article) may exhibit 100 percent biodegradation within not more than 2 years, measured according to ISO 17556 (2012) under soil composting conditions.

Additionally, or in the alternative, the melt-processable, plasticized cellulose ester composition (or melt or melt-formed article) described herein may exhibit a biodegradation of at least 90 percent within not more than about 700, 650, 600, 550, 500, 450, 400, 350, 300, 275, 250, 240, 230, 220, 210, 200, or 195 days, measured according 17556 (2012) under soil composting conditions. In some cases, the composition (or melt or melt-formed article) may be at least about 97, 98, 99, or 99.5 percent biodegradable within not more than about 225, 220, 215, 210, 205, 200, or 195 days of testing according to ISO 17556 (2012) under soil composting conditions. As a result, the composition (or melt or melt-formed article) described herein may meet the requirements to receive the OK biodegradable SOIL conformity mark of Vingotte and to meet the standards of the DIN Gepruft Biodegradable in soil certification scheme of DIN CERTCO.

In some embodiments, cellulose ester composition (or melt or melt-formed article) of the present invention may include less than 1, 0.75, 0.50, or 0.25 weight percent of components of unknown biodegradability. In some cases, the composition (or melt or melt-formed article) described herein may include no components of unknown biodegradability.

In addition to being biodegradable under industrial and/or home composting conditions, the melt-processable, plasticized cellulose ester composition (or melt or melt-formed article) as described herein may also be compostable under home and/or industrial conditions. As described previously, a material is considered compostable if it meets or exceeds the requirements set forth in EN 13432 for biodegradability, ability to disintegrate, heavy metal content, and ecotoxicity. The composition (or melt or melt-formed article) described herein may exhibit sufficient compostability under home and/or industrial composting conditions to meet the requirements to receive the OK compost and OK compost HOME conformity marks from Vingotte.

In some cases, the melt-processable, plasticized cellulose ester composition (or melt or melt-formed article) described herein may have a volatile solids concentration, heavy metals and fluorine content that fulfill all of the requirements laid out by EN 13432 (2000). Additionally, the melt-processable, plasticized cellulose ester composition (or melt or melt-formed article) may not cause a negative effect on compost quality (including chemical parameters and ecotoxicity tests).

In some cases, the melt-processable, plasticized cellulose ester composition (or melt or melt-formed article) may exhibit a disintegration of at least 90 percent within not more than 26 weeks, measured according to ISO 16929 (2013) under industrial composting conditions. In some cases, the melt-processable, plasticized cellulose ester composition (or melt or melt-formed article) may exhibit a disintegration of at least about 91, 92, 93, 94, 95, 96, 97, 98, 99, or 99.5 percent under industrial composting conditions within not more than 26 weeks, or the melt-processable, plasticized cellulose ester composition (or melt or melt-formed article) may be 100 percent disintegrated under industrial composting conditions within not more than 26 weeks. Alternatively, or in addition, the melt-processable, plasticized cellulose ester composition (or melt or melt-formed article) may exhibit a disintegration of at least 90 percent under industrial compositing conditions within not more than about 26, 25, 24, 23, 22, 21, 20, 19, 18, 17, 16, 15, 14, 13, 12, 11, or 10 weeks, measured according to ISO 16929 (2013). In some cases, the melt-processable, plasticized cellulose ester composition (or melt or melt-formed article) described herein may be at least 97, 98, 99, or 99.5 percent disintegrated within not more than 12, 11, 10, 9, or 8 weeks under industrial composting conditions, measured according to ISO 16929 (2013).

In some embodiments, the melt-processable, plasticized cellulose ester composition (or melt or melt-formed article) may exhibit a disintegration of at least 90 percent within not more than 26 weeks, measured according to ISO 16929 (2013) under home composting conditions. In some cases, the melt-processable, plasticized cellulose ester composition (or melt or melt-formed article) may exhibit a disintegration of at least about 91, 92, 93, 94, 95, 96, 97, 98, 99, or 99.5 percent under home composting conditions within not more than 26 weeks, or the composition (or melt or melt-formed article) may be 100 percent disintegrated under home composting conditions within not more than 26 weeks. Alternatively, or in addition, the melt-processable, plasticized cellulose ester composition (or melt or melt-formed article) may exhibit a disintegration of at least 90 percent within not more than about 26, 25, 24, 23, 22, 21, 20, 19, 18, 17, 16, or 15 weeks under home composting conditions, measured according to ISO 16929 (2013). In some embodiments, the melt-processable, plasticized cellulose ester composition (or melt or melt-formed article) described herein may be at least 97, 98, 99, or 99.5 percent disintegrated within not more than 20, 19, 18, 17, 16, 15, 14, 13, or 12 weeks, measured under home composting conditions according to ISO 16929 (2013).

The present application also discloses a pellet formed from any of the melt-processable, plasticized cellulose ester compositions disclosed herein.

In embodiments or in combination with any other embodiments, the melt-processable, plasticized cellulose ester composition is formed into a pellet.

In embodiments or in combination with any other embodiments, the article is an oriented film, an oriented sheet, a foam sheet, or a fiber. An oriented film or sheet is formed by stretching a formed film or sheet (e.g., by extrusion). The stretching can be biaxially, uniaxially, or angular. In one class of this embodiment, the oriented film or oriented sheet are biaxially, uniaxially, or angularly stretched.

In embodiments or in combination with any other embodiments, when the melt-processable, plasticized cellulose ester composition is melt-formed into a film having a thickness of 0.13, or 0.25. or 0.38, or 0.51, or 0.64, or 0.76, or 0.89, or 1.02, or 1.14, or 1.27, or 1.40, or 1.52 mm, the film exhibits greater than 90% disintegration after 12 weeks according to Disintegration Test Protocol, as described in the specification or in the alternative according to ISO 16929 (2013). In certain embodiments, when the melt-processable, plasticized cellulose ester composition is melt-formed into a film having a thickness of 0.76, or 0.89, or 1.02, or 1.14, or 1.27, or 1.40, or 1.52 mm, the film exhibits greater than 90% disintegration after 12 weeks according to Disintegration Test Protocol, as described in the specification or in the alternative according to ISO 16929 (2013). In certain embodiments, when the melt-processable, plasticized cellulose ester composition is melt-formed into a film having a thickness of 0.13, or 0.25. or 0.38, or 0.51, or 0.64, or 0.76, or 0.89, or 1.02, or 1.14, or 1.27, or 1.40, or 1.52 mm, the film exhibits greater than 90, or 95, or 96, or 97, or 98, or 99% disintegration after 12 weeks according to Disintegration Test Protocol, as described in the specification or in the alternative according to ISO 16929 (2013). In certain embodiments, when the melt-processable, plasticized cellulose ester composition is melt-formed into a film having a thickness of 0.13, or 0.25. or 0.38, or 0.51, or 0.64, or 0.76, or 0.89, or 1.02, or 1.14, or 1.27, or 1.40, or 1.52 mm, the film exhibits greater than 90, or 95, or 96, or 97, or 98, or 99% disintegration after 8, or 9, or 10, or 11, or 12, or 13, or 14, or 15, or 16 weeks according to Disintegration Test Protocol, as described in the specification or in the alternative according to ISO 16929 (2013).

In some embodiments, the melt-processable, plasticized cellulose ester composition (or melt or melt-formed article) described herein may be substantially free of photodegradation agents. For example, the melt-processable, plasticized cellulose ester composition (or melt or melt-formed article) may include not more than about 1, 0.75, 0.50, 0.25, 0.10, 0.05, 0.025, 0.01, 0.005, 0.0025, or 0.001 weight percent of photodegradation agent, based on the total weight of the composition (or melt or melt-formed article), or the melt-processable, plasticized cellulose ester composition (or melt or melt-formed article) may include no photodegradation agents. Examples of such photodegradation agents include, but are not limited to, pigments which act as photooxidation catalysts and are optionally augmented by the presence of one or more metal salts, oxidizable promoters, and combinations thereof. Pigments may include coated or uncoated anatase or rutile titanium dioxide, which may be present alone or in combination with one or more of the augmenting components such as, for example, various types of metals. Other examples of photodegradation agents include benzoins, benzoin alkyl ethers, benzophenone and its derivatives, acetophenone and its derivatives, quinones, thioxanthones, phthalocyanine and other photosensitizers, ethylene-carbon monoxide copolymer, aromatic ketone-metal salt sensitizers, and combinations thereof.

In an aspect, melt-formed biodegradable and/or compostable articles are provided that include, are formed from or are prepared using the melt-processable, plasticized cellulose ester compositions, as described herein. In embodiments, the articles are made from moldable thermoplastic material comprising the melt-processable, plasticized cellulose ester compositions, as described herein.

In embodiments, the melt-formed articles are single use food contact articles. Examples of such articles that may be made with the compositions include cups, trays, multi-compartment trays, clamshell packaging, films, sheets, trays and lids (e.g., thermoformed), candy sticks, stirrers, straws, plates, bowls, portion cups, food packaging, liquid carrying containers, solid or gel carrying containers, and cutlery. In embodiments, the melt-formed articles may be horticultural articles. Examples of such articles that may be made with the melt-processable, plasticized cellulose ester compositions include plant pots, plant tags, mulch films, and agricultural ground cover.

In another aspect, a cellulose ester composition is provided that comprises recycle cellulose ester prepared by an integrated process which comprises the processing steps of: (1) preparing a recycled plastic content syngas in a synthesis gas operation utilizing a feedstock that contains a solid fossil fuel source and at least some content of recycled plastics; (2) preparing at least one chemical intermediate from said syngas; (3) reacting said chemical intermediate in a reaction scheme to prepare at least one cellulose reactant for preparing a recycle cellulose acetate, and/or selecting said chemical intermediate to be at least one cellulose reactant for preparing a recycle cellulose acetate; and (4) reacting said at least one cellulose reactant to prepare said recycle cellulose ester; wherein said recycle cellulose ester comprises at least one substituent on an anhydroglucose unit (AGU) derived from recycled plastic content syngas.

In embodiments, the processing steps (1) to (4) are carried out in a system that is in fluid and/or gaseous communication (i.e., including the possibility of a combination of fluid and gaseous communication. It should be understood that the chemical intermediates, in one or more of the reaction schemes for producing recycle cellulose acetates starting from recycled plastic content syngas, may be temporarily stored in storage vessels and later reintroduced to the integrated process system.

In embodiments, the at least one chemical intermediate is chosen from methanol, methyl acetate, acetic anhydride, acetic acid, or combinations thereof. In embodiments, one chemical intermediate is methanol, and the methanol is used in a reaction scheme to make a second chemical intermediate that is acetic anhydride. In embodiments, the cellulose reactant is acetic anhydride.

In embodiments, the melt-processable, plasticized cellulose ester composition comprises cellulose ester, a plasticizer composition and a stabilizer composition, wherein the plasticizer composition comprises one or more food grade plasticizers and is present in an amount from 5% to 30% or 5% to 25% or 5% to 20% or 5% to 17% or 5% to 15% or 5% to 10% wt %, based on the total weight of the melt-processable, plasticized cellulose ester composition. When present, the optional stabilizer composition comprises one or more secondary antioxidants and is present in an amount from 0.08 to 0.8, or 0.08 to 0.7, or 0.08 to 0.6 wt %, based on the total weight of the melt-processable, plasticized cellulose ester composition.

In embodiments, the plasticizer composition comprises triacetin in an amount from 5 to 20 wt %, based on the total weight of the melt-processable, plasticized cellulose ester composition; and the optional stabilizer composition comprises one or more secondary antioxidants in an amount from 0.1 to 0.4, or 0.1 to 0.3 wt % and one or more primary antioxidants in an amount from 0.1 to 0.4, or 0.2 to 0.4 wt %, where wt % is based on the total weight of the melt-processable, plasticized cellulose ester composition. In one class of this embodiment, the one or more secondary antioxidants comprises a phosphite compound (e.g., Weston 705T or Doverphos S-9228T), DLTDP or a combination thereof and the one or more primary antioxidants comprises Irganox 1010, BHT or a combination thereof. In embodiments, the melt-processable, plasticized cellulose ester composition has a b* less than 40, or less than 35, or less than 30, or less than 25, or less than 20, or less than 15 after normal cycle time during injection molding (as described in the examples); or has a b* less than 40, or less than 35, or less than 30, or less than 25, or less than 20 after doubling the cycle time during injection molding.

In embodiments, the plasticizer composition comprises polyethylene glycol an average molecular weight of from 300 to 500 Daltons in an amount from 5% to 20% by weight, based on the total weight of the melt-processable, plasticized cellulose ester composition; and the optional stabilizer composition comprises one or more secondary antioxidants in an amount from 0.01 to 0.8, or 0.1 to 0.5, or 0.1 to 0.3, or 0.1 to 0.2 wt %, based on the total weight of the melt-processable, plasticized cellulose ester composition. In one class of this embodiment, the one or more secondary antioxidants comprises a phosphite compound (e.g., Weston 705T or Doverphos S-9228T), DLTDP or a combination thereof. In another class of this embodiment, the stabilizer composition further comprises one or more primary antioxidants (e.g., Irganox 1010 or BHT), citric acid or a combination thereof, wherein the one or more primary antioxidants are present in an amount from 0.1 to 0.5, or 0.1 to 0.4 wt %, based on the total weight of the melt-processable, plasticized cellulose ester composition, and wherein the citric acid is present in an amount from 0.05 to 0.2, or 0.05 to 0.15 wt %, based on the total weight of the melt-processable, plasticized cellulose ester composition.

In embodiments, the plasticizer composition comprises polyethylene glycol an average molecular weight of from 300 to 500 Daltons in an amount from 5% to 20% or 5% to 17% or 5% to 16% or 5% to 15% by weight, based on the total weight of the melt-processable, plasticized cellulose ester composition; and the optional stabilizer composition comprises one or more secondary antioxidants in an amount from 0.1 to 0.5, or 0.1 to 0.3, or 0.1 to 0.2 wt %, based on the total weight of the melt-processable, plasticized cellulose ester composition.

The present application also discloses a cellulose acetate composition comprising: (1) a cellulose acetate, wherein the cellulose acetate has an acetyl degree of substitution (“DS_{A}c”) in the range of from 2.2 to 2.6, (2) from 5 to 20 wt % of a polyethylene glycol or a methoxy polyethylene glycol composition having an average molecular weight of from 300 Daltons to 550 Daltons, and (3) a hydrocolloid, wherein the composition is melt processable and biodegradable and an article including, prepared using or formed from is biodegradable.

In one embodiment or in combination with any other embodiment, the composition comprises polyethylene glycol having an average molecular weight of from 300 to 500 Daltons.

In one embodiment or in combination with any other embodiment, the melt-processable, plasticized cellulose ester composition comprises polyethylene glycol having an average molecular weight of from 350 to 550 Daltons.

In one embodiment or in combination with any other embodiment, the cellulose acetate has a number average molecular weight (“Mn”) in the range of from 10,000 to 90,000 Daltons, as measured by GPC. In one embodiment or in combination with any other embodiment, the cellulose acetate has a number average molecular weight (“Mn”) in the range of from 30,000 to 90,000 Daltons, as measured by GPC. In one embodiment or in combination with any other embodiment, the cellulose acetate has a number average molecular weight (“Mn”) in the range of from 40,000 to 90,000 Daltons, as measured by GPC.

In one embodiment or in combination with any other embodiment, wherein when the melt-processable, plasticized cellulose ester composition is melt-formed into a film having a thickness of 0.38 mm, the film exhibits greater than 5% disintegration after 6 weeks and greater than 90% disintegration after 12 weeks according to the Disintegration Test Protocol, as described in the specification or in the alternative according to ISO 16929 (2013). In one embodiment or in combination with any other embodiment, wherein when the melt-processable, plasticized cellulose ester composition is melt-formed into a film having a thickness of 0.38 mm, the film exhibits greater than 10% disintegration after 6 weeks and greater than 90% disintegration after 12 weeks according to Disintegration Test Protocol, as described in the specification or in the alternative according to ISO 16929 (2013). In one embodiment or in combination with any other embodiment, wherein when the melt-processable, plasticized cellulose ester composition is melt-formed into a film having a thickness of 0.38 mm, the film exhibits greater than 20% disintegration after 6 weeks and greater than 90% disintegration after 12 weeks according to Disintegration Test Protocol, as described in the specification or in the alternative according to ISO 16929 (2013). In one embodiment or in combination with any other embodiment, wherein when the melt-processable, plasticized cellulose ester composition is melt-formed into a film having a thickness of 0.38 mm, the film exhibits greater than 30% disintegration after 6 weeks and greater than 90% disintegration after 12 weeks according to Disintegration Test Protocol, as described in the specification or in the alternative according to ISO 16929 (2013). In one embodiment or in combination with any other embodiment, wherein when the melt-processable, plasticized cellulose ester composition is melt-formed into a film having a thickness of 0.38 mm, the film exhibits greater than 50% disintegration after 6 weeks and greater than 90% disintegration after 12 weeks according to Disintegration Test Protocol, as described in the specification or in the alternative according to ISO 16929 (2013). In one embodiment or in combination with any other embodiment, wherein when the melt-processable, plasticized cellulose ester composition is melt-formed into a film having a thickness of 0.38 mm, the film exhibits greater than 70% disintegration after 6 weeks and greater than 90% disintegration after 12 weeks according to Disintegration Test Protocol, as described in the specification or in the alternative according to ISO 16929 (2013).

In one embodiment or in combination with any other embodiment, when the melt-processable, plasticized cellulose ester composition is melt-formed into a film having a thickness of 0.76 mm, the film exhibits greater than 30% disintegration after 12 weeks according to Disintegration Test Protocol, as described in the specification or in the alternative according to ISO 16929 (2013). In one embodiment or in combination with any other embodiment, when the melt-processable, plasticized cellulose ester composition is melt-formed into a film having a thickness of 0.76 mm, the film exhibits greater than 50% disintegration after 12 weeks according to Disintegration Test Protocol, as described in the specification or in the alternative according to ISO 16929 (2013). In one embodiment or in combination with any other embodiment, when the melt-processable, plasticized cellulose ester composition is melt-formed into a film having a thickness of 0.76 mm, the film exhibits greater than 70% disintegration after 12 weeks according to Disintegration Test Protocol, as described in the specification or in the alternative according to ISO 16929 (2013). In one embodiment or in combination with any other embodiment, when the melt-processable, plasticized cellulose ester composition is melt-formed into a film having a thickness of 0.76 mm, the film exhibits greater than 90% disintegration after 12 weeks according to Disintegration Test Protocol, as described in the specification or in the alternative according to ISO 16929 (2013). In one embodiment or in combination with any other embodiment, when the melt-processable, plasticized cellulose ester composition is melt-formed into a film having a thickness of 0.76 mm, the film exhibits greater than 95% disintegration after 12 weeks according to Disintegration Test protocol, as described in the specification or in the alternative according to ISO 16929 (2013).

In one embodiment or in combination with any other embodiment, the melt-processable, plasticized cellulose ester composition further comprises at least one additional component chosen from a filler, an additive, a biopolymer, a stabilizer, or an odor modifier.

In one embodiment or in combination with any other embodiment, the melt-processable, plasticized cellulose ester composition further comprises a filler in an amount of from 1 to 60 wt %, based on the total weight of the composition. In one class of this embodiment, the filler is a carbohydrate, a cellulosic filler, an inorganic filler, a food byproduct, a desiccant, an alkaline filler, or combinations thereof.

In one subclass of this class, the filler is an inorganic filler. In one sub-subclass of this subclass, the inorganic filer is calcium carbonate.

In one subclass of this class, the filler is a carbohydrate. In one subclass of this class, the filler is a cellulosic filler. In one subclass of this class, the filler is a food byproduct. In one subclass of this class, the filler is a desiccant. In one subclass of this class, the filler is an alkaline filler.

In one embodiment or in combination with any other embodiment, the melt-processable, plasticized cellulose ester composition further comprises an odor modifying additive in an amount of from 0.001 to 1 wt %, based on the total weight of the composition. In one class of this embodiment, the odor modifying additive is vanillin, Pennyroyal M-1178, almond, cinnamyl, spices, spice extracts, volatile organic compounds or small molecules, Plastidor or combinations thereof. In one subclass of this class, the odor modifying additive is vanillin.

In one embodiment or in combination with any other embodiment, the melt-processable, plasticized cellulose ester composition further comprises a stabilizer in an amount from 0.01 to 5 wt %, based on the total composition. In one class of this embodiment, the stabilizer is a UV absorber, an antioxidant (e.g., ascorbic acid, BHT, BHA, etc), an acid scavenger, a radical scavenger, an epoxidized oil (e.g., epoxidized soybean oil, epoxidized linseed oil, epoxidized sunflower oil), or combinations.

In one embodiment or in combination with any other embodiment, the melt-processable, plasticized cellulose ester composition comprises polyethylene glycol having an average molecular weight of from 300 to 500 Daltons. In one embodiment or in combination with any other embodiment, the melt-processable, plasticized cellulose ester composition comprises polyethylene glycol having an average molecular weight of from 350 to 550 Daltons.

The present application also discloses article such as a melt-formed article comprising, formed from or prepared using a cellulose acetate composition comprising: (1) a cellulose acetate, wherein the cellulose acetate has an acetyl degree of substitution (“DS_{Ac}”) in the range of from 2.2 to 2.6; (2) from 5 to 20 wt % of a polyethylene glycol or a methoxy polyethylene glycol composition having an average molecular weight of from 300 Daltons to 550 Daltons; and (3) a hydrocolloid; wherein the composition is melt-processable and may be biodegradable.

In one embodiment or in combination with any other embodiment, the article is formed from an orienting process, an extrusion process, an injection molding process, a blow molding process, or a thermoforming process. In one class of this embodiment, the article is formed from the orienting process. In one subclass of this class, the orienting process is a uniaxial stretching process or a biaxial stretching process.

In one class of this embodiment, the article is formed from the extrusion process. In one class of this embodiment, the article is formed from the injection molding process. In one class of this embodiment, the article is formed from the blow molding process. In one class of this embodiment, the article is formed from a thermoforming process. In one subclass of this class, the article includes, is formed from or is prepared using a film or sheet of from 10 mil to 160 mil in thickness.

In one embodiment or in combination with any other embodiment, when the article is a clear or transparent article, the article exhibits a haze of less than 10%. In one embodiment or in combination with any other embodiment, when the article is a clear or transparent article, the article exhibits a haze of less than 8%. In one embodiment or in combination with any other embodiment, when the article is a clear or transparent article, the article exhibits a haze of less than 6%. In one embodiment or in combination with any other embodiment, when the article is a clear or transparent article, the article exhibits a haze of less than 5%. In one embodiment or in combination with any other embodiment, when the article is a clear or transparent article, the article exhibits a haze of less than 4%. In one embodiment or in combination with any other embodiment, when the article is a clear or transparent article, the article exhibits a haze of less than 3%. In one embodiment, when the article is a clear or transparent article, the article exhibits a haze of less than 2%. In one embodiment or in combination with any other embodiment, when the article is a clear or transparent article, the article exhibits a haze of less than 1%.

In one embodiment or in combination with any other embodiment, when the melt-processable, plasticized cellulose ester composition is melt-formed into a film having a thickness of 0.76 mm, the film exhibits greater than 30% disintegration after 12 weeks according to Disintegration Test Protocol, as described in the specification or in the alternative according to ISO 16929 (2013). In one embodiment or in combination with any other embodiment, when the composition is formed into a film having a thickness of 0.76 mm, the film exhibits greater than 50% disintegration after 12 weeks according to Disintegration Test Protocol, as described in the specification or in the alternative according to ISO 16929 (2013). In one embodiment or in combination with any other embodiment, when the melt-processable, plasticized cellulose ester composition is melt-formed into a film having a thickness of 0.76 mm, the film exhibits greater than 70% disintegration after 12 weeks according to Disintegration Test Protocol, as described in the specification or in the alternative according to ISO 16929 (2013). In one embodiment or in combination with any other embodiment, when the melt-processable, plasticized cellulose ester composition is melt-formed into a film having a thickness of 0.76 mm, the film exhibits greater than 90% disintegration after 12 weeks according to Disintegration Test Protocol, as described in the specification or in the alternative according to ISO 16929 (2013). In one embodiment or in combination with any other embodiment, when the melt-processable, plasticized cellulose ester composition is melt-formed into a film having a thickness of 0.76 mm, the film exhibits greater than 95% disintegration after 12 weeks according to Disintegration Test Protocol, as described in the specification or in the alternative according to ISO 16929 (2013).

In one embodiment or in combination with any other embodiment, the melt-formed article exhibits greater than 30% disintegration after 12 weeks according to Disintegration Test Protocol, as described in the specification or in the alternative according to ISO 16929 (2013). In one embodiment or in combination with any other embodiment, the melt-formed article exhibits greater than 50% disintegration after 12 weeks according to Disintegration Test Protocol, as described in the specification or in the alternative according to ISO 16929 (2013). In one embodiment or in combination with any other embodiment, the melt-formed article exhibits greater than 70% disintegration after 12 weeks according to Disintegration Test Protocol, as described in the specification or in the alternative according to ISO 16929 (2013). In one embodiment or in combination with any other embodiment, the melt-formed article exhibits greater than 80% disintegration after 12 weeks according to Disintegration Test Protocol, as described in the specification or in the alternative according to ISO 16929 (2013). In one embodiment or in combination with any other embodiment, the melt-formed article exhibits greater than 90% disintegration after 12 weeks according to Disintegration Test Protocol, as described in the specification or in the alternative according to ISO 16929 (2013). In one embodiment or in combination with any other embodiment, the melt-formed article exhibits greater than 95% disintegration after 12 weeks according to Disintegration Test Protocol, as described in the specification or in the alternative according to ISO 16929 (2013).

In one embodiment or in combination with any other embodiment, the melt-formed article has a thickness of 0.8 mm or less. In one embodiment, the melt-formed article has a thickness of 0.76 mm or less.

The present application also discloses an article comprising a cellulose acetate composition comprising: (1) a cellulose acetate, wherein the cellulose acetate has an acetyl degree of substitution (“DS_{A}c”) in the range of from 2.2 to 2.6, (2) from 13-23 wt % of a polyethylene glycol or a methoxy polyethylene glycol composition having an average molecular weight of from 300 Daltons to 550 Daltons, (3) a hydrocolloid; and (4) 0.01-1.8 wt % of an additive chosen from an epoxidized soybean oil, a secondary antioxidant, or a combination, wherein the composition is melt processable, biodegradable, and disintegratable.

In one embodiment or in combination with any other embodiment, the additive is present at from 0.01 to 1 wt %, or 0.05 to 0.8 wt %, or 0.05 to 0.5 wt %, or 0.1 to 1 wt %.

In one embodiment or in combination with any other embodiment, the additive is an epoxidized soybean oil which is present at 0.1 to 1 wt %, or 0.1 to 0.5 wt %, or 0.5 to 1 wt %, or 0.3 to 0.8 wt %.

In one embodiment or in combination with any other embodiment, the additive is a secondary antioxidant which is present at 0.01 to 0.8 wt %, or 0.01 to 0.4 wt %, or 0.4 to 0.8 wt %, or 0.2 to 0.6 wt %.

In one embodiment or in combination with any other embodiment, the melt-processable, plasticized cellulose ester composition comprises polyethylene glycol having an average molecular weight of from 300 to 500 Daltons. In one embodiment or in combination with any other embodiment, the composition comprises polyethylene glycol having an average molecular weight of from 350 to 550 Daltons.

In one embodiment or in combination with any other embodiment, the article is formed from an orienting process, an extrusion process, an injection molding process, a blow molding process, or a thermoforming process. In one class of this embodiment, the article is formed from the orienting process. In one subclass of this class, the orienting process is a uniaxial stretching process or a biaxial stretching process.

In one class of this embodiment, the article is formed from the extrusion process. In one class of this embodiment, the article is formed from the injection molding process. In one class of this embodiment, the article is formed from the blow molding process. In one class of this embodiment, the article is formed from a thermoforming process. In one subclass of this class, the film or sheet used to form the article is from 10 to 160 mil thick.

In one embodiment or in combination with any other embodiment, when the composition is formed into a film having a thickness of 0.76 mm, the film exhibits greater than 30% disintegration after 12 weeks according to Disintegration Test Protocol, as described in the specification or in the alternative according to ISO 16929 (2013). In one embodiment or in combination with any other embodiment, when the composition is formed into a film having a thickness of 0.76 mm, the film exhibits greater than 50% disintegration after 12 weeks according to Disintegration Test Protocol, as described in the specification or in the alternative according to ISO 16929 (2013). In one embodiment or in combination with any other embodiment, when the composition is formed into a film having a thickness of 0.76 mm, the film exhibits greater than 70% disintegration after 12 weeks according to Disintegration Test Protocol, as described in the specification or in the alternative according to ISO 16929 (2013). In one embodiment or in combination with any other embodiment, when the composition is formed into a film having a thickness of 0.76 mm, the film exhibits greater than 90% disintegration after 12 weeks according to Disintegration Test Protocol, as described in the specification or in the alternative according to ISO 16929 (2013). In one embodiment or in combination with any other embodiment, when the composition is formed into a film having a thickness of 0.76 mm, the film exhibits greater than 95% disintegration after 12 weeks according to Disintegration Test Protocol, as described in the specification or in the alternative according to ISO 16929 (2013).

In one embodiment or in combination with any other embodiment, the article exhibits greater than 30% disintegration after 12 weeks according to Disintegration Test Protocol, as described in the specification or in the alternative according to ISO 16929 (2013). In one embodiment or in combination with any other embodiment, the article exhibits greater than 50% disintegration after 12 weeks according to Disintegration Test Protocol, as described in the specification or in the alternative according to ISO 16929 (2013). In one embodiment or in combination with any other embodiment, the article exhibits greater than 70% disintegration after 12 weeks according to Disintegration Test Protocol, as described in the specification or in the alternative according to ISO 16929 (2013). In one embodiment or in combination with any other embodiment, the article exhibits greater than 80% disintegration after 12 weeks according to Disintegration Test Protocol, as described in the specification or in the alternative according to ISO 16929 (2013). In one embodiment or in combination with any other embodiment, the article exhibits greater than 90% disintegration after 12 weeks according to Disintegration Test Protocol, as described in the specification or in the alternative according to ISO 16929 (2013). In one embodiment or in combination with any other embodiment, the article exhibits greater than 95% disintegration after 12 weeks according to Disintegration Test Protocol, as described in the specification or in the alternative according to ISO 16929 (2013).

In one embodiment or in combination with any other embodiment, the article has a thickness of 0.8 mm or less. In one embodiment, the article has a thickness of 0.76 mm or less.

In one or more embodiments, the melt-processable plasticized cellulose acetate composition of the present invention is a foamable composition. In one or more embodiments, the melt processable, plasticized foamable composition of the present invention includes (i) cellulose acetate; (ii) plasticizer; (iii) a hydrocolloid; (iv) optionally, at least one nucleating agent; and (v) at least one blowing agent selected from the group consisting of a physical blowing agent, a chemical blowing composition comprising a chemical blowing agent and carrier polymer and combinations thereof.

In one embodiment or in combination with any other embodiment, the foamable composition exhibits a heat deflection temperature of greater than 100° C. as measured at 0.45 MPa at 2% elongation with a 1 Hz frequency using a DMA. In one embodiment or in combination with any other embodiment, the foamable composition exhibits a heat deflection temperature of greater than 102° C. as measured at 0.45 MPa at 2% elongation with a 1 Hz frequency using a DMA. In one embodiment or in combination with any other embodiment, the foamable composition exhibits a heat deflection temperature of greater than 104° C. as measured at 0.45 MPa at 2% elongation with a 1 Hz frequency using a DMA. In one embodiment or in combination with any other embodiment, the foamable composition exhibits a heat deflection temperature of greater than 106° C. as measured at 0.45 MPa at 2% elongation with a 1 Hz frequency using a DMA. In one embodiment or in combination with any other embodiment, the foamable composition exhibits a heat deflection temperature of greater than 110° C. as measured at 0.45 MPa at 2% elongation with a 1 Hz frequency using a DMA. In one embodiment or in combination with any other embodiment, the foamable composition exhibits a heat deflection temperature of greater than 115° C. as measured at 0.45 MPa at 2% elongation with a 1 Hz frequency using a DMA.

In one embodiment or in combination with any other embodiment, the blowing agent comprises sodium bicarbonate, citric acid or combination thereof. In one class of this embodiment, the blowing agent comprises sodium bicarbonate. In one class of this embodiment, the blowing agent comprises citric acid.

In one embodiment or in combination with any other embodiment, the carrier polymer comprises a carrier polymer comprises a polybutylene succinate (“PBS”), a polycaprolactone (“PCL”), a polylactic acid (“PLA”), a polyhydroxyalkanoate (“PHA”), a polybutylene adipate terephthalate (“PBAT”), a starch derivative, a poly(butylene succinate-co-butylene adipate) (“PBSA”), or combinations thereof. In one subclass of this class, the carrier polymer comprises a PBS. In one subclass of this class, the carrier polymer comprises a PCL. In one subclass of this class, the carrier polymer is a PLA. In one subclass of this class, the carrier polymer is a PHA. In one subclass of this class, the carrier polymer is a PBAT. In one subclass of this class the carrier polymer is a starch. In one subclass of this class, the carrier polymer is PBSA.

In one embodiment or in combination with any other embodiment, the plasticizer comprises triacetin, triethyl citrate, or PEG400.

In one class of this embodiment, the plasticizer is present in a range of from 3 to 30 wt %. In one class of this embodiment, the plasticizer is present in a range of from 3 to 30 or from 3 to 25 wt %.

In one class of this embodiment, the plasticizer comprises triacetin.

In one subclass of this class, the plasticizer is present in a range of from 3 to 30 wt %. In one subclass of this class, the plasticizer is present in a range of from 3 to 30 or 3 to 25 wt %.

In one class of this embodiment, the plasticizer comprises triethyl citrate. In one subclass of this class, the plasticizer is present in a range of from 3 to 30 wt %. In one subclass of this class, the plasticizer is present in a range of from 3 to 30 or 3 to 25 wt %.

In one class of this embodiment, the plasticizer comprises PEG400. In one subclass of this class, the plasticizer is present in a range of from 3 to 30 wt %. In one subclass of this class, the plasticizer is present in a range of from 3 to 30 or 3 to 25 wt %.

In one embodiment or in combination with any other embodiment, the nucleating agent comprises a magnesium silicate, a silicon dioxide, a magnesium oxide, or combinations thereof. In one class of this embodiment, the nucleating agent comprises a particulate composition with a median particle size less than 2 microns. In one class of this embodiment, the nucleating agent comprises a particulate composition with a median particle size less than 1.5 microns. In one class of this embodiment, the nucleating agent comprises a particulate composition with a median particle size less than 1.1 microns.

In one class of this embodiment, the nucleating agent comprises a magnesium silicate. In one subclass of this class, the nucleating agent comprises a particulate composition with a median particle size less than 2 microns. In one subclass of this class, the nucleating agent comprises a particulate composition with a median particle size less than 1.5 microns. In one subclass of this class, the nucleating agent comprises a particulate composition with a median particle size less than 1.1 microns.

In one class of this embodiment, the nucleating agent comprises a silicon dioxide. In one subclass of this class, the nucleating agent comprises a particulate composition with a median particle size less than 2 microns. In one subclass of this class, the nucleating agent comprises a particulate composition with a median particle size less than 1.5 microns. In one subclass of this class, the nucleating agent comprises a particulate composition with a median particle size less than 1.1 microns.

In one class of this embodiment, the nucleating agent comprises a magnesium oxide. In one subclass of this class, the nucleating agent comprises a particulate composition with a median particle size less than 2 microns. In one subclass of this class, the nucleating agent comprises a particulate composition with a median particle size less than 1.5 microns. In one subclass of this class, the nucleating agent comprises a particulate composition with a median particle size less than 1.1 microns.

In one embodiment or in combination with any other embodiment, the nucleating agent comprises a particulate composition with a median particle size less than 2 microns. In one embodiment, the nucleating agent comprises a particulate composition with a median particle size less than 1.5 microns. the nucleating agent comprises a particulate composition with a median particle size less than 1.1 microns.

In one embodiment or in combination with any other embodiment, the foamable composition further comprises a fiber. In one class of this embodiment, the fiber comprises hemp, bast, jute, flax, ramie, kenaf, sisal, bamboo, or wood cellulose fibers. In one subclass of this class, the fiber comprises hemp.

In one embodiment or in combination with any other embodiment, the foamable composition further comprises a photodegradation cellulose catalyst. In one class of this embodiment, the photodegradation cellulose catalyst is a titanium dioxide, or an iron oxide. In one subclass of this class, the photodegradation cellulose catalyst is a titanium dioxide. In one subclass of this class, the photodegradation cellulose catalyst is an iron oxide.

In one embodiment or in combination with any other embodiment, the foamable composition further comprises a pigment. In one class of this embodiment, the pigment is a titanium dioxide, a cellulose carbon black, or an iron oxide. In one subclass of this class, the pigment is a titanium dioxide. In one subclass of this class, the pigment is a cellulose carbon black. In one subclass of this class, the pigment is an iron oxide.

In one embodiment or in combination with any other embodiment, the foamable composition is biodegradable.

In one embodiment or in combination with any other embodiment, the foamable composition comprises two or more cellulose acetates having different degrees of substitution of acetyl.

In one embodiment or in combination with any other embodiment, the foamable composition further comprises a biodegradable polymer that is different than the cellulose acetate.

In one embodiment or in combination with any other embodiment, there is an article prepared from any one of the previously described foamable compositions, wherein the article is a foam or a foam article.

In one class of this embodiment, the article has a thickness of up to 3 mm.

In one class of this embodiment, the article has one or more skin layers. The skin layer may be found on the outer surface of the article or foam. The skin layer cellulose acetate also be found in the middle of the foam.

In one class of this embodiment, the article is biodegradable.

In one or more embodiments, in particular for embodiments wherein the article is a foam or a foam article, density of the foam is an important parameter insofar as it may influence various article performance properties such as water barrier, stiffness and thermal conductivity. In one class of this embodiment, the article has a density or the article includes foam with a density less than 0.9 g/cm³. In one class of this embodiment, the article has a density or the article includes foam with a density of less than 0.8 g/cm³. In one class of this embodiment, the article has a density or the article includes foam with a density of less than 0.7 g/cm³. In one class of this embodiment, the article has a density or the article includes foam with a density of less than 0.6 g/cm³. In one class of this embodiment, the article has a density or the article includes foam with a density Of less than 0.5 g/cm³. In one class of this embodiment, the article has a density or the article includes foam with a density of less than 0.4 g/cm³. In one class of this embodiment, the article has a density or the article includes foam with a density of less than 0.3 g/cm³. In one class of this embodiment, the article has a density or the article includes foam with a density of less than 0.2 g/cm³. In one class of this embodiment, the article has a density or the article includes foam with a density of less than 0.1 g/cm³. In one class of this embodiment, the article has a density or the article includes foam with a density of less than 0.05 g/cm³. In one class of this embodiment, the article has a density or the article includes foam with a density in the range of from 0.2 to 0.9 g/cm³. In one or more embodiments, the article has a density, or the article includes foam with a density, of from 0.01 to 0.2 g/cm³.

In one class of this embodiment, the article is industrial compostable or home compostable. In one subclass of this class, the article is industrial compostable. In one sub-subclass of this subclass, the article has a thickness that is less than 1.1 mm. In one subclass of this class, the article is home compostable. In one sub-subclass of this subclass, the article has a thickness that is less than 1.1 mm. In one sub-subclass of this subclass, the article has a thickness that is less than 0.8 mm. In one sub-subclass of this subclass, the article has a thickness that is less than 0.6 mm. In one sub-subclass of this subclass, the article has a thickness that is less than 0.4 mm.

In one embodiment or in combination with any other embodiment, wherein when the foamable composition is formed into a foam having a thickness of 0.38 mm, the foam exhibits greater than 5% disintegration after 6 weeks and greater than 90% disintegration after 12 weeks according to the Disintegration Test Protocol, as described in the specification or in the alternative according to ISO 16929 (2013). In one embodiment or in combination with any other embodiment, wherein when the foamable composition is formed into a foam having a thickness of 0.38 mm, the foam exhibits greater than 10% disintegration after 6 weeks and greater than 90% disintegration after 12 weeks according to Disintegration Test Protocol, as described in the specification or in the alternative according to ISO 16929 (2013). In one embodiment or in combination with any other embodiment, wherein when the foamable composition is formed into a foam having a thickness of 0.38 mm, the foam exhibits greater than 20% disintegration after 6 weeks and greater than 90% disintegration after 12 weeks according to Disintegration Test Protocol, as described in the specification or in the alternative according to ISO 16929 (2013). In one embodiment or in combination with any other embodiment, wherein when the composition is formed into a foam having a thickness of 0.38 mm, the foam exhibits greater than 30% disintegration after 6 weeks and greater than 90% disintegration after 12 weeks according to Disintegration Test Protocol, as described in the specification or in the alternative according to ISO 16929 (2013). In one embodiment or in combination with any other embodiment, wherein when the foamable composition is formed into a foam having a thickness of 0.38 mm, the foam exhibits greater than 50% disintegration after 6 weeks and greater than 90% disintegration after 12 weeks according to Disintegration Test Protocol, as described in the specification or in the alternative according to ISO 16929 (2013). In one embodiment or in combination with any other embodiment, wherein when the foamable composition is formed into a foam having a thickness of 0.38 mm, the foam exhibits greater than 70% disintegration after 6 weeks and greater than 90% disintegration after 12 weeks according to Disintegration Test Protocol, as described in the specification or in the alternative according to ISO 16929 (2013).

In one embodiment or in combination with any other embodiment, when the foamable composition is formed into a foam having a thickness of 0.76 mm, the foam exhibits greater than 30% disintegration after 12 weeks according to Disintegration Test Protocol, as described in the specification or in the alternative according to ISO 16929 (2013). In one embodiment or in combination with any other embodiment, when the foamable composition is formed into a foam having a thickness of 0.76 mm, the foam exhibits greater than 50% disintegration after 12 weeks according to Disintegration Test Protocol, as described in the specification or in the alternative according to ISO 16929 (2013). In one embodiment or in combination with any other embodiment, when the foamable composition is formed into a foam having a thickness of 0.76 mm, the foam exhibits greater than 70% disintegration after 12 weeks according to Disintegration Test Protocol, as described in the specification or in the alternative according to ISO 16929 (2013). In one embodiment or in combination with any other embodiment, when the foamable composition is formed into a foam having a thickness of 0.76 mm, the foam exhibits greater than 90% disintegration after 12 weeks according to Disintegration Test Protocol, as described in the specification or in the alternative according to ISO 16929 (2013). In one embodiment or in combination with any other embodiment, when the foamable composition is formed into a foam having a thickness of 0.76 mm, the foam exhibits greater than 95% disintegration after 12 weeks according to Disintegration Test protocol, as described in the specification or in the alternative according to ISO 16929 (2013).

In one or more embodiments, the present invention may be a foamable composition that includes: (i) a cellulose acetate; (ii) plasticizer; (iii) a hydrocolloid; (iv) optionally a nucleating agent; and (v) blowing agent. In one or more embodiments, the foamable composition may include (1) a cellulose acetate having a degree of substitution of acetyl (DS_{Ac}) between 2.2 to 2.6; (2) 5 to 40 wt % of a plasticizer; (3) a hydrocolloid; (4) 0.1 to 3 wt % of a nucleating agent; and (5) 0.1 to 15 wt % of a physical blowing agent, wherein the proportions of the cellulose acetate, plasticizer, nucleating agent and physical blowing agent are based on the total weight of the foamable composition. The blowing agent is preferably a physical blowing agent.

In one embodiment or in combination with any other embodiment, the foamable composition exhibits a heat deflection temperature (HDT) of greater than 100° C. as measured at 0.45 MPa at 2% elongation with a 1 Hz frequency using a DMA. In one embodiment or in combination with any other embodiment, the foamable composition exhibits a heat deflection temperature of greater than 102° C. as measured at 0.45 MPa at 2% elongation with a 1 Hz frequency using a DMA. In one embodiment or in combination with any other embodiment, the foamable composition exhibits a heat deflection temperature of greater than 104° C. as measured at 0.45 MPa at 2% elongation with a 1 Hz frequency using a DMA. In one embodiment or in combination with any other embodiment, the foamable composition exhibits a heat deflection temperature of greater than 106° C. as measured at 0.45 MPa at 2% elongation with a 1 Hz frequency using a DMA. In one embodiment or in combination with any other embodiment, the foamable composition exhibits a heat deflection temperature of greater than 110° C. as measured at 0.45 MPa at 2% elongation with a 1 Hz frequency using a DMA. In one embodiment or in combination with any other embodiment, the foamable composition exhibits a heat deflection temperature of greater than 115° C. as measured at 0.45 MPa at 2% elongation with a 1 Hz frequency using a DMA. The heat deflection temperature is a measure of a material's resistance to distortion under a constant load at elevated temperature. For example, ASTM D648 and ISO 75 both measure HDT (heat deflection temperature) on test samples after equilibration of the test materials. Briefly, a test bar is molded of a specific thickness and width. The test sample is submerged in oil for which the temperature is raised at a uniform rate (usually 2° C. per minute). The load is applied to the midpoint of the test bar that is supported near both ends. The temperature at which a bar of material is deformed 0.25 mm is recorded as the HDT.

In one embodiment or in combination with any other embodiment, the physical blowing agent comprises CO₂, N, unbranched or branched (C₂₋₆)alkane, or any combination thereof. In one class of this embodiment, the physical blowing agent comprises CO₂. In one class of this embodiment, the physical blowing agent comprises N₂. In one class of this embodiment, the physical blowing agent comprises unbranched or branched (C₂₋₆)alkane.

In one embodiment or in combination with any other embodiment, the physical blowing agent is present from 0.1 to 0.5 wt %. In one embodiment or in combination with any other embodiment, the physical blowing agent is present from 0.5 to 4 wt %. In one embodiment or in combination with any other embodiment, the physical blowing agent is present from 0.3 to 4 wt %. In one embodiment or in combination with any other embodiment, the physical blowing agent is present from 4 to 10 wt %.

In one embodiment or in combination with any other embodiment, the plasticizer comprises triacetin, triethyl citrate, or PEG400.

In one class of this embodiment, the plasticizer is present in a range of from 3 to 30% wt %. In one class of this embodiment, the plasticizer is present in a range of from 3 to 25 wt % or 3 to 20 wt. % or 3 to 15 wt. %.

In one class of this embodiment, the plasticizer comprises triacetin.

In one subclass of this class, the plasticizer is present in a range of from 3 to 30 wt %. In one subclass of this class, the plasticizer is present in a range of from 3 to 25 wt % or 3 to 20 wt. % or 3 to 15 wt. %.

In one class of this embodiment, the plasticizer comprises triethyl citrate. In one subclass of this class, the plasticizer is present in a range of from 3 to 30 wt %. In one subclass of this class, the plasticizer is present in a range of from 3 to 25 wt % or 3 to 20 wt. % or 3 to 15 wt. %.

In one class of this embodiment, the plasticizer comprises PEG400. In one subclass of this class, the plasticizer is present in a range of from 3 to 30 wt %. In one subclass of this class, the plasticizer is present in a range of from 3 to 25 wt % or 3 to 20 wt. % or 3 to 15 wt. %.

In one embodiment or in combination with any other embodiment wherein the foamable composition includes a nucleating agent, the nucleating agent comprises a magnesium silicate, a silicon dioxide, a magnesium oxide, or combinations thereof. In one class of this embodiment, the nucleating agent comprises a particulate composition with a median particle size less than 2 microns. In one class of this embodiment, the nucleating agent comprises a particulate composition with a median particle size less than 1.5 microns. In one class of this embodiment, the nucleating agent comprises a particulate composition with a median particle size less than 1.1 microns.

In one class of this embodiment, the nucleating agent comprises a magnesium silicate. In one subclass of this class, the nucleating agent comprises a particulate composition with a median particle size less than 2 microns. In one subclass of this class, the nucleating agent comprises a particulate composition with a median particle size less than 1.5 microns. In one subclass of this class, the nucleating agent comprises a particulate composition with a median particle size less than 1.1 microns.

In one class of this embodiment, the nucleating agent comprises a silicon dioxide. In one subclass of this class, the nucleating agent comprises a particulate composition with a median particle size less than 2 microns. In one subclass of this class, the nucleating agent comprises a particulate composition with a median particle size less than 1.5 microns. In one subclass of this class, the nucleating agent comprises a particulate composition with a median particle size less than 1.1 microns.

In one class of this embodiment, the nucleating agent comprises a magnesium oxide. In one subclass of this class, the nucleating agent comprises a particulate composition with a median particle size less than 2 microns. In one subclass of this class, the nucleating agent comprises a particulate composition with a median particle size less than 1.5 microns. In one subclass of this class, the nucleating agent comprises a particulate composition with a median particle size less than 1.1 microns.

In one embodiment or in combination with any other embodiment, the nucleating agent comprises a particulate composition with a median particle size less than 2 microns. In one embodiment, the nucleating agent comprises a particulate composition with a median particle size less than 1.5 microns. the nucleating agent comprises a particulate composition with a median particle size less than 1.1 microns.

In one embodiment or in combination with any other embodiment, the foamable composition further comprises a fiber. In one class of this embodiment, the fiber comprises hemp, bast, jute, flax, ramie, kenaf, sisal, bamboo, or wood cellulose fibers. In one subclass of this class, the fiber comprises hemp.

In one embodiment or in combination with any other embodiment, the foamable composition further comprises a photodegradation catalyst. In one class of this embodiment, the photodegradation catalyst is a titanium dioxide, or an iron oxide. In one subclass of this class, the photodegradation catalyst is a titanium dioxide. In one subclass of this class, the photodegradation catalyst is an iron oxide.

In one embodiment or in combination with any other embodiment, the foamable composition further comprises a pigment. In one class of this embodiment, the pigment is a titanium dioxide, a cellulose carbon black, or an iron oxide. In one subclass of this class, the pigment is a titanium dioxide. In one subclass of this class, the pigment is a carbon black. In one subclass of this class, the pigment is an iron oxide.

In one embodiment or in combination with any other embodiment, the foamable composition is biodegradable.

In one embodiment or in combination with any other embodiment, the foamable composition comprises two or more cellulose acetates having different degrees of substitution of acetyl.

In one embodiment or in combination with any other embodiment, the foamable composition further comprises a biodegradable polymer that is different than the cellulose acetate.

In one embodiment or in combination with any other embodiment, there is an article prepared from any one of the previously described foamable compositions, wherein the article is a foam or a foam article. In one or more embodiments, the foam article is formed from or includes a foam of the present invention.

In one class of this embodiment, the article has a thickness or foam thickness of up to 3 mm.

In one class of this embodiment, the article has one or more skin layers.

In one class of this embodiment, the article is a melt-formed article that may be one or more of biodegradable, disintegratable and compostable.

In one class of this embodiment, the article includes foam with a density less than 0.9 g/cm³. In one class of this embodiment, the article has a density, or the article includes foam with a density, of less than 0.8 g/cm³. In one class of this embodiment, the article has a density, or the article includes foam with a density of less than 0.7 g/cm³. In one class of this embodiment, the article has a density of less than 0.6 g/cm³. In one class of this embodiment, the article has a density, or the article includes foam with a density, of less than 0.5 g/cm³. In one class of this embodiment, the article has a density, or the article includes foam with a density, of less than 0.4 g/cm³. In one class of this embodiment, the article has a density, or the article includes foam with a density of less than 0.3 g/cm³. In one class of this embodiment, the article has a density, or the article includes foam with a density of less than 0.2 g/cm³. In one class of this embodiment, the article has a density, or the article includes foam with a density, of less than 0.1 g/cm³. In one class of this embodiment, the article has a density, or the article includes foam with a density of less than 0.05 g/cm³. In one class of this embodiment, the article has a density in the range of from 0.2 to 0.9 g/cm³.

In one class of this embodiment, the article is industrial compostable or home compostable. In one subclass of this class, the article is industrial compostable. In one sub-subclass of this subclass, the article has a thickness that is less than 6 mm. In one sub-subclass of this subclass, the article has a thickness that is less than 3 mm. In one sub-subclass of this subclass, the article has a thickness that is less than 1.1 mm. In one subclass of this class, the article is home compostable. In one sub-subclass of this subclass, the article has a thickness that is less than 6 mm. In one sub-subclass of this subclass, the article has a thickness that is less than 3 mm. In one sub-subclass of this subclass, the article has a thickness that is less than 1.1 mm. In one sub-subclass of this subclass, the article has a thickness that is less than 0.8 mm. In one sub-subclass of this subclass, the article has a thickness that is less than 0.6 mm. In one sub-subclass of this subclass, the article has a thickness that is less than 0.4 mm.

In one embodiment or in combination with any other embodiment, the article has a thickness that is less than 6 mm. In one embodiment or in combination with any other embodiment, the article has a thickness that is less than 3 mm. In one embodiment or in combination with any other embodiment, the article has a thickness that is less than 1.1 mm. In one embodiment or in combination with any other embodiment, the article has a thickness that is less than 0.8 mm. In one embodiment or in combination with any other embodiment, the article has a thickness that is less than 0.6 mm. In one embodiment or in combination with any other embodiment, the article has a thickness that is less than 0.4 mm.

The present application discloses a method for preparing a foamable composition comprising: (a) providing a nonfoamable composition comprising (1) a cellulose acetate having a degree of substitution of acetyl (DSAc) between 2.2 to 2.6, (2) 5 to 40 wt % of a plasticizer, (3) a hydrocolloid, and (4) 0.1 to 3 wt % of a nucleating agent; (b) melting the nonfoamable composition in an extruder to form a melt of the nonfoamable composition; and (b) injecting a physical blowing agent into the melt of the nonfoamable composition to prepare a melted foamable composition.

In one embodiment or in combination with any other embodiment, the physical blowing agent comprises CO₂, N₂ or an unbranched or branched (C₂₋₆)alkane.

In one embodiment or in combination with any other embodiment, the foam or foam article exhibits greater than 30% disintegration after 12 weeks according to Disintegration Test Protocol, as described in the specification or in the alternative according to ISO 16929 (2013). In one embodiment or in combination with any other embodiment, the foam or foam article exhibits greater than 50% disintegration after 12 weeks according to Disintegration Test Protocol, as described in the specification or in the alternative according to ISO 16929 (2013). In one embodiment or in combination with any other embodiment, the foam or foam article exhibits greater than 70% disintegration after 12 weeks according to Disintegration Test Protocol, as described in the specification or in the alternative according to ISO 16929 (2013). In one embodiment or in combination with any other embodiment, the foam or foam article exhibits greater than 80% disintegration after 12 weeks according to Disintegration Test Protocol, as described in the specification or in the alternative according to ISO 16929 (2013). In one embodiment or in combination with any other embodiment, the foam or article exhibits greater than 90% disintegration after 12 weeks according to Disintegration Test Protocol, as described in the specification or in the alternative according to ISO 16929 (2013). In one embodiment or in combination with any other embodiment, the foam article exhibits greater than 95% disintegration after 12 weeks according to Disintegration Test Protocol, as described in the specification or in the alternative according to ISO 16929 (2013).

The present invention exhibits a number of surprising characteristics and achieves many unexpected performance and processing parameters. The plasticized cellulose ester compositions of the present invention may exhibit improved melt strength and melt viscosity while maintaining the physical properties and characteristics of cellulose esters. The plasticized cellulose ester compositions of the present invention may also exhibit surprising and unexpected increases in the extensibility (drawability or stretchability) of the formulation when heated above the glass transition temperature (Tg) as well as increased extensibility below the glass transition temperature. Of further and particular note is the improvement/increase in areal (planar) draw ratio, which translates to improved stretchability in melt-formed thermoplastic applications. Improving the drawability or extensibility of melt-processable plasticized cellulose ester compositions can broaden its processing window, especially for stretching processes like blown film extrusion, thermoforming and fiber spinning. Improved drawability can also extend the possible range of applications for melt-processable plasticized cellulose ester compositions to include articles with high draw ratios that would otherwise be excluded. If the drawability of plasticized cellulose acetate could be increased, then the melt strength is likely to be higher.

The observed advantages of the present invention may be useful for example in foam articles or foaming processes where melt strength is desired such as blown film, extrusion blowing molding, minimizing sag in thermoforming and extrusion and controlling cell size in foaming. Interestingly, compositions of the present invention also improved strain hardening over controls. Further, the hydrocolloids present in the compositions of the present invention may be water dispersible or water soluble and therefore may serve as disintegration enhancers and enable higher compostability thicknesses.

These and other benefits and advantages of the present invention are demonstrated in the examples set forth below, which are provided as merely illustrative of embodiments of the present invention and are not intended to limit its spirit and scope.

### EXAMPLES

The materials utilized in performance of the examples are set forth below. All percentages in the examples are by weight based on the total weight of the composition unless otherwise indicated.

TABLE A
Materials

| Material | Grade, Tradename | Supplier |
|---|---|---|
| Cellulose ester | Eastman Cellulose Acetate | Eastman |
| | CA-398-30 | |
| Plasticizer P1 | PEG400, Sentry Grade | Dow |
| Plasticizer P2 | Triacetin, Food Grade | Eastman |
| Hydrocolloid HC1 | Acacia powder #36499, | Alfa Aesar |
| | R&D grade | |
| Hydrocolloid HC2 | Acacia gum TIC ® Pre- | Ingredion |
| | Hydrated ® Gum Arabic | |
| | Spray Dry Powder | |
| Hydrocolloid HC3 | Acacia gum TIC ® ARAB-FT | Ingredion/ICI |
| Hydrocolloid HC4 | CAPSUL ® modified starch, | Ingredion/ICI |
| | Sodium octenyl succinate | |
| | starch | |
| Hydrocolloid HC5 | Xanthan gum, food | Hodgson Mill |
| | ingredient | |
| Hydrocolloid HC6 | Tara gum, Caesalpinia | Making |
| | spinosa gum | Cosmetics |
| Hydrocolloid HC7 | Karaya gum, CAS 9000-36-6 | Sigma Aldrich |
| | | #G0503 |
| Hydrocolloid HC8 | Tragacanth gum, CAS | Sigma Aldrich |
| | 9000-65-1 | #G1128 |
| Hydrocolloid HC9 | Carrageenan (iota), | Sigma-Aldrich |
| | Commercial grade, Type II | #C1138 |
| Hydrocolloid HC10 | Chitosan | Aldrich, |
| | | #417963 |
| Hydrocolloid HC11 | CMC, Carboxymethyl | Sigma-Aldrich |
| | cellulose, sodium salt, CAS | #419311 |
| | 9004-32-4 | |
| Hydrocolloid HC12 | Klucel ™ LF, | Ashland |
| | Hydroxypropylcellulose | |
| Hydrocolloid HC13 | GUMPLETE Fenugreek | Ingredion/ICI |
| | Gum 75000258 | |

### Example 1. Compression Molded Films Containing 1 wt % Hydrocolloid

Films were pressed from dry blends of Eastman cellulose acetate (CA) grade CA398-30 with 1 wt % Hydrocolloid and either 15 wt % Triacetin or 15 wt % PEG400 as plasticizer. The dry ingredients were sieved together 3 times to mix and disperse the hydrocolloid additive in the CA powder. Then the plasticizer was added, and the mixture was blended together in an electric coffee bean grinder to disperse the plasticizer. Each dry blend was weighed into aluminum pans and dried at 80° C. for 24 hours. Films were pressed for a total of 4 minutes on a heated press with the upper and lower platens pre-heated to 425° F. (218° C.). The pre-dried CA/Plasticizer/Hydrocolloid dry blend was applied to the center of a 4-inch square, 10 mil thick frame between a top and bottom layer of aluminum foil, all between two steel plates. The assembly was placed in the press and heated for 1 min at 0 pressure to dry and pre-melt the puck, then pressed for 1 minute at 12,000 PHI, bumped up to higher pressure over ˜30 seconds, and finally held for 1.5 minute at 20,000 PSI (Ram force in pounds).

The appearance and ductility of the compression molded films is summarized in the Table below. The molded films that were visually uniform and ductile were taken as indications of compatibility and thermal stability of the hydrocolloid additive at 1%

TABLE 1

| | | | Film |
|---|---|---|---|
| Hydrocolloid additive (1 wt %) | | Film Appearance | Ductility |
| HC1 | Acacia gum (ALFA) | Visually uniform | Ductile |
| HC2 | Acacia TIC, Pre-hydrate (granules) | Brown specks | Ductile |
| HC4 | CAPSUL SOSS | Uniform | Ductile |
| HC5 | Xanthan gum | Brown specks | Brittle |
| HC6 | Tara gum | Visually uniform | Ductile |
| HC7 | Karaya gum | Brown specks | Brittle, |
| | | | odor |
| HC8 | Tragacanth gum | Visually uniform | Ductile |
| HC9 | Carrageenan (iota form) | Degraded, | |
| | | charred | |
| HC10 | Chitosan | Dark brown | Odor |
| HC11 | CMC | Visually uniform | Ductile |
| HC12 | Klucel LF (HPC) | Hazy, white | Ductile |
| | | streaks | |

### Example 2. Compounding & Sheet Extrusion

To form melt-processable plasticized cellulose ester compositions of the present invention, ingredients were compounded and pellets formed using a Leistritz twin screw at a 15-lb scale. Representative extruder conditions are detailed below in Table 2 below. Compositions are set forth in Table 3 below. Xanthan gum has been reported to form non-covalent crosslinks in the presence of citric acid.

TABLE 2
Compounding Extruder Settings

| | |
|---|---|
| Load/Torque % | 17 |
| Screw RPM | 568 |
| Melt Temperature | 260 |
| Melt Pressure | 575 |
| Die Type/Inj. Size | 1/SMALL |
| Sample Size | 20 |
| SEI | 0.135 |

| Barrel Temperature | Set | Actual |
|---|---|---|
| Zone 1 | 80 | 80 |
| Zone 2 | 160 | 160 |
| Zone 3 | 200 | 200 |
| Zone 4 | 215 | 215 |
| Zone 5 | 215 | 215 |
| Zone 6 | 215 | 215 |
| Zone 7 | 225 | 225 |
| Zone 8 | 225 | 225 |
| Zone 9 | 240 | 240 |
| Die 1 | 240 | 240 |
| Die 2 | 240 | 240 |

| | Rate | Percent |
|---|---|---|
| Feeder 1 | 16.4 | 42 |
| Feeder 2 | | |
| Feeder 3 | | |

TABLE 3
Compositions

| BATCH | 80 | 81 | 82 | 94 | 98 | 99 | 100 | 101 | 102 |
|---|---|---|---|---|---|---|---|---|---|
| CA398-30 (wt %) | 84 | 84 | 84 | 79 | 84 | 84 | 83 | 78 | 78 |
| Vikoflex (wt %) | 1 | 1 | 1 | 1 | 1 | 1 | 1 | 1 | 1 |
| Plasticizer (wt %) | 15P1 | P1 | P1 | P2 | P1 | P1 | P1 | P2 | P1 |
| | (15) | (15) | (15) | (20) | (15) | (15) | (15) | (20) | (20) |
| Hydrocolloid (wt %) | HC10 | HC6 | HC1, | | HC5 | HC5 | HC2 | HC2 | HC1 |
| | (1) | (1) | (1) | | (1) | (1) | (2) | (2) | (1) |
| Other additive (wt %) | | | | | | Citric | | | |
| | | | | | | acid | | | |
| | | | | | | (0.5) | | | |

### Example 3. Dispersibility of Hydrocolloids in Extruded Film

30 mil films were then melt extruded from each batch of pellets using a 1.5 inch Killion sheet extruder equipped with a Maddock mixing screw and an adjustable sheet/film die. Nominal temperature/die temperature/melt temperature/barrel temp range=375° F. to 466° F.; rpm=30 to 70. Dispersibility and compatibility of polysaccharide hydrocolloids in plasticized CA was assessed by visual inspection of the films extruded above with results set forth in Table 4 below. Acacia gum appeared miscible with CA while other gums and polysaccharides remained intact after the extrusion process.

TABLE 4
Appearance of extruded films of plasticized
Cellulose acetate with 1-2 wt % Hydrocolloids

| Polysaccharide | |
|---|---|
| Hydrocolloid | |
| Additive | Appearance of 30 mil extruded films (CA398-30), |
| (at 1 wt % to 2 wt %) | plasticized with PEG400 or Triacetin |
| HC10 | Not dispersible at 1 wt %, appears as brown |
| | flecks in the film (#80) |
| HC6 | Not dispersible at 1 wt %, appears as brown |
| | flecks in the film (#81) |
| HC5 | Not dispersible at 1 wt %, appears as brown |
| | flecks in the film (#98, #99) |
| Acacia gum (HC1 | Dispersible at 1 to 2 wt % - films are |
| and HC2) | translucent with no inclusions and light |
| | brown (#82, 100, 101, 102) |

Chitosan, Xanthan gum and Tara gum did not incorporate homogeneously in the films. In contrast, Acacia gum added at 1 wt % was well-dispersed in the films and was also dispersible at 2 wt %.

### Example 4. Thermal Properties of Extruded Films

The extruded films of Example 3 were subjected to Differential Scanning Calorimetry (DSC) to determine Specific Heat Capacity (SHC) in the first heat and Glass transition temperature (Tg) in the second heat. Differential Scanning Calorimetry (DSC) was completed using a TA Instruments Q2000 device which determines thermal transitions of the polymer. To analyze the samples, (4 to 8 mg) of each sample was sealed in aluminum DSC pans and evaluated using a heat-cool-heat method. For the 1^{st} heat, the samples were evaluated from 23° C. to 250° C. at a scan rate of 20° C. per minute and transitions were marked. Next the sample was cooled from 250° C. to 23° C. at a scan rate of 20° C. per minute and transitions were marked. Finally, the samples were reheated a second time (second heat method) from 23° C. to 250° C. at a scan rate of 20° C. per minute and the transitions were marked. The Tg was determined during the 2^{nd} heat to minimize the impact of moisture on the sample results. Transitions are marked and recorded in accordance with ASTM D3418.

TABLE 5
Thermal Properties

| | SHC | |
|---|---|---|
| | J/(g · C) at | |
| Batch | 23° C. | Tg (DSC 2^{nd} heat) |
| 80 | 1.75 | 128.03 |
| 81 | 1.69 | 129.12 |
| 82 | 1.83 | 126.37 |
| 100 | 1.88 | 128.29 |
| 102 | 2.18 | Too subtle to identify |
| 94 | 1.96 | 110.33 |
| 101 | 1.87 | 111.30 |

### Example 5. Stretchability Below Tg

The extruded films of Example 3 were subjected to tensile testing according to ASTM D882 with testing conducted at ambient conditions of 20° C. and 50% relative humidity (RH). Results are set forth in Tables 6a and 6b below.

TABLE 6a
Tensile Testing

| | (Control) | 82 | 100 |
|---|---|---|---|
| ASTM D882 Mean | 15 wt % | 15 wt % PEG400 | 15 wt % PEG400 |
| (std dev) | PEG400 | 1 wt % Acacia | 2 wt % Acacia |
| mil | 31 | 29 | 29 |
| TD Break strain (%) | 47.3 | 53.9 | 42.6 |
| Energy at break | 16.2 | 19.9 | 15.2 |
| (N*mm/mm3) | | | |
| MD Break strain (%) | 51.2 | 58.3 | 49.2 |
| Energy at break | 17.8 | 21.4 | 17.9 |

TABLE 6b
Tensile Testing

| | 94-94 | 94-101 |
|---|---|---|
| ASTM D882 Mean (std | (Control) | 20 wt % TA |
| dev) | 20 wt % TA | 2 wt % Acacia |
| mil | 28 | 27 |
| Break strain (%) | 38.3 | 36.0 |
| Energy at break | 13.5 | 13.2 |
| (N*mm/mm3) | | |
| Break strain (%) | 43.8 | 41.5 |
| Energy at break | 16.0 | 15.8 |

Film from batch 82, with 1 wt % Acacia gum, had a higher Break strain (elongation at break) in both the Machine Direction (MD) and the Transverse Direction (TD) than a similar film without Acacia gum.

### Example 6. Stretchability Above Tg; Draw Ratio

Sheets of extruded films from Example 3 were thermoformed by male plug-assist vacuum molding in a Comet model C64S thermoformer. The mold was a multi-cavity mold with nine cylindrical cups arranged in a 3×3 grid. Each cup was 2 inches in diameter, while the depth varied from ¼ to 2¼ inches, resulting in a range of areal draw ratios (ADRs) from 1.5 to 5.5. The male plug was designed to result in a clearance of 100 μm between the female and the male mold. Each extruded sheet was clamped on two sides and heated to a target sheet temperature of Tg+75° C. The actual sheet surface temperature was measured with an IR thermometer in several places. The sag of the sheet was measured during heating. Lower sag may be indicative of reduced distortion or wrinkling during molding. The mean sag of the sheet is recorded in Table 7a.

The heated sheet was positioned over the mold and thermoformed into formed cups. Formed cups were visually inspected for defects (including stress-whitening/discoloration and tears/holes), with the formed cups with no visual defects recorded as “intact” as set forth in Table 7b, while samples with visible defects are not recorded (i.e., left blank in the Table). The highest draw ratio achieved without introduction of visible defects for a given sample is labeled for purposes of this test as the maximum areal draw ratio.

As evidenced by the data in Table 7b, the maximum areal draw ratio (ADR) for formed cups formed with a control sheet 80 with 15 wt % PEG400 was 3.5 to 4. The addition of 1% hydrocolloid (acacia gum) increased the maximum ADR to at least 5 to 5.5, which was the limit of the mold device used for the test.

TABLE 7A
Sag measurement

| | | Mean | |
|---|---|---|---|
| | | sag | IR temp range (° C.) |
| Batch | Additives | (mm) | Target is Tg + 75 |
| 80 | 15 wt % PEG400 | 164 | 181-194 |
| 82 | 15 wt % PEG400, | <125 | 180-187 |
| | 1 wt % Acacia gum | | |

TABLE 7B
Maximum areal draw ratio

| | | | | | 82 | | |
|---|---|---|---|---|---|---|---|
| | | 15 wt % PEG400 | | | 15 wt % PEG400 | | |
| | Areal | (Control) | | | 1 wt % Acacia gum | | |
| | draw | Replicate # | | | | | |
| Cup # | ratio | 1 | 2 | 3 | 1 | 2 | 3 |
| 1 | 1.5 | Intact | Intact | Intact | Intact | Intact | Intact |
| 2 | 2.0 | Intact | Intact | Intact | Intact | Intact | Intact |
| 3 | 2.5 | Intact | Intact | Intact | Intact | Intact | Intact |
| 4 | 3.0 | Intact | Intact | Intact | Intact | Intact | Intact |
| 5 | 3.5 | Intact | Intact | Intact | Intact | Intact | Intact |
| 6 | 4.0 | Intact | Intact | | Intact | Intact | Intact |
| 7 | 4.5 | | | | Intact | Intact | Intact |
| 8 | 5.0 | | | | | Intact | Intact |
| 9 | 5.5 | | | | Intact | Intact | Intact |

### Example 7. Demonstration of Deep Draw Thermoforming for Varying Concentration of PEG400 and Hydrocolloid Additive (Acacia Gum)

Sheets of extruded films from Example 3 with varying concentrations of PEG400 and hydrocolloid additive (acacia gum) were subjected to thermoforming by male plug-assist vacuum molding. The thermoforming equipment, mold and procedure followed were the same as described in Example 6. The sheet surface temperature (° C.), sag (mm) and highest areal draw ratio (ADR) obtained were recorded for each sample in replicates, averaged and tabulated in Table 8. Sheet temperature was recorded at several points across the sheet using an IR thermometer positioned right above the clamping frame. Sag was measured using a GoPro camera setup that was calibrated from the bottom of the clamping frame to the lowest point of the sagging sheet. The clamping frame blocked the camera from viewing the initial gap of approximately 125 mm between the clamped sheet and the bottom of the clamping frame, hence any sheet for which the sag was not visible below the bottom of the clamping frame was recorded as <125 mm. Maximum ADR was defined and recorded for the purposes of this test as the ADR of the mold cavity for which the cups were formed without any visual defects, such as stress whitening, discoloration, tears, or holes. As evidenced in Table 8, the max ADR of 5.5 (limit of the mold used) with the lowest sag, indicative of higher melt viscosity and reduced distortion/wrinkling during molding, was obtained for the sheet 82 with 15 wt % PEG400 and 1 wt % hydrocolloid (acacia gum). A higher concentration of plasticizer (PEG400) by itself did not significantly influence the average sag and max ADR, as seen from sheets 80 and 94. However, the addition of a 1-2 wt % of a hydrocolloid additive (acacia gum) increased the max ADR, evidenced by sheets 82, 100 and 102.

TABLE 8
IR temperature, sag, and maximum DR data for varying concentrations
of PEG400 and hydrocolloid additive (acacia gum).

| | | IR Temp. | Mean | Maximum areal DR | | | |
|---|---|---|---|---|---|---|---|
| | | Range | Sag | (Max ADR) | | | |
| Batch | Additives (wt %) | (° C.) | (mm) | 1 | 2 | 3 | Mean |
| 80 | PEG400 (15) | 182-188 | 157 | 4.0 | 4.0 | 3.5 | 3.8 |
| 82 | PEG400 (15), | 181-184 | 177 | 5.5 | 4.5 | — | 5.0 |
| | Acacia Gum (1) | | | | | | |
| 100 | PEG400 (15), | 183-191 | 153 | 3.5 | 4.5 | 4.5 | 4.2 |
| | Acacia Gum (2) | | | | | | |
| 94 | PEG400 (20) | 168-175 | 174 | 4.0 | 3.5 | 3.5 | 3.7 |
| 102 | PEG400 (20), | 169-177 | 167 | 4.5 | 4.5 | 5 | 4.7 |
| | Acacia Gum (1) | | | | | | |

### Example 8. Demonstration of Deep Draw Thermoforming for Various Types of Hydrocolloid Additives

Sheets of extruded films compounded with different types of hydrocolloids (acacia gum, modified starch and tragacanth gum) were subjected to thermoforming by male plug-assist vacuum molding. The thermoforming equipment, mold and procedure followed were the same as described in Example 6. The sheet surface temperature (° C.), sag (mm) and highest areal draw ratio (ADR) obtained were recorded for each sample in replicates as described in Example 7, averaged, and tabulated in Table 9. It can be observed from Table 9 that the addition of 1 wt % of a hydrocolloid additive (acacia gum, modified starch or tragacanth gum) along with 15 wt % PEG400 plasticizer significantly increases the max ADR obtained, as compared to the control sheet 80 with only 15 wt % PEG400.

TABLE 9
IR temperature, sag, and maximum DR data for
varying types of hydrocolloid additive (acacia
gum, modified starch, tragacanth gum).

| | | IR Temp. | Mean | | | | |
|---|---|---|---|---|---|---|---|
| | | range | Sag | Max ADR | | | |
| Batch | Additives (wt %) | (° C.) | (mm) | n = 1 | n = 2 | n = 3 | Mean |
| 80 | PEG400 (15) | 165-178 | <125 | 3.0 | 3.5 | 4.0 | 3.5 |
| 82 | PEG400 (wt %), | 171-183 | <125 | 5.5 | 5.0 | 5.5 | 5.3 |
| | Acacia Gum (1) | | | | | | |
| 83 | PEG400 (15), | 175-184 | 165 | 4.5 | 5.5 | 5 | 5.0 |
| | Modified | | | | | | |
| | Starch | | | | | | |
| | (CAPSUL ®) (1) | | | | | | |
| 84 | PEG400 (15), | 177-183 | 160 | 5.5 | 4.5 | 5.5 | 5.2 |
| | Tragacanth | | | | | | |
| | Gum (1) | | | | | | |

### Example 9. Extensional Rheological Properties of Extruded Films

Uniaxial elongational flow properties of the 30 mil (0.76 mm) extruded film samples from Example 8 were characterized on a TA Instruments ARES-G2 rotational rheometer with a Sentmanat Extensional Rheometer (SER) fixture, which consists of two counter-rotating drums with intermeshing gears and low-friction bearings. A specimen of 3″ (76.2 mm) length and 0.5″ (12.7 mm) width is cut from the extruded film and the ends are secured to the two drums, set at the desired test temperature, using securing clamps. The test temperature used was determined to Tg+75° C., similar to the thermoforming temperature. Rotation of the rheometer drive shaft makes the drums rotate in opposite directions, which causes the ends of the specimen film to be wound up onto the drums and thus resulting in the specimen film being uniformly stretched over an unsupported extended length. The specimen film is stretched at a constant rate until the point of fracture, and the rheometer torque and axial force data is converted into extensional viscosity which is plotted as a function of Hencky strain (ε_{H}) or time. The elongational rheology tests enable the quantification of the strain hardening property, which provides a direct insight into the melt strength and melt extensibility characteristics of the polymer material. The degree of strain hardening (SH) was determined using the following equation: SH=η_{E}/3η₀, where η_{E} (Pa·s) is the apparent elongational viscosity obtained from the peak of the elongational viscosity curve as a function of Hencky strain (ε_{H}). no is the zero-shear viscosity measured by means of dynamic frequency sweep experiments on a rotational rheometer using parallel plate fixtures. Table 10 lists the values of η₀, ε_{H}, η_{E} and SH for the samples with and without the hydrocolloid additive. The SH results correlate well with the thermoforming stretchability data of Example 8, where the sample films with 15 wt % PEG400 and 1 wt % hydrocolloid (modified starch, tragacanth gum or acacia gum) display significantly higher SH compared to the sample with only 15 wt % PEG400 (control sheet 80).

TABLE 10
Uniaxial elongational flow properties

| | Additives | η₀ | | η_{E} | Degree |
|---|---|---|---|---|---|
| Batch | (wt %) | (Pa · s) (×10³) | ε_{H} | (Pa · s)(×10⁵) | of SH |
| 80 | PEG400 (15) | 2.00 | 1.88 | 4.46 | 74.2 |
| 82 | PEG400 (15), | 1.79 | 2.33 | 5.79 | 107.8 |
| | Acacia Gum | | | | |
| | (1) | | | | |
| 83 | PEG400 (15), | 1.89 | 2.25 | 5.75 | 101.2 |
| | Modified | | | | |
| | Starch | | | | |
| | (Capsul) (1) | | | | |
| 84 | PEG400 (15), | 1.98 | 2.59 | 6.08 | 102.2 |
| | Gum | | | | |
| | Tragacanth | | | | |
| | (1) | | | | |

1. A melt-processable plasticized cellulose ester composition, said composition comprising (i) cellulose ester; (ii) plasticizer; and (iii) a hydrocolloid.

2. The melt-processable plasticized cellulose ester composition of claim 1 wherein the hydrocolloid is present in an amount of from 0.1 to 49% by weight based on the total weight of the melt-processable plasticized cellulose ester composition.

3. The melt-processable plasticized cellulose ester composition of claim 2 wherein the hydrocolloid is present in an amount of from 0.5% to 20% by weight based on the total weight of the melt-processable plasticized cellulose ester composition.

4. The melt-processable plasticized cellulose ester composition of claim 2 wherein the hydrocolloid is present in an amount of from 0.1% to 5% by weight based on the total weight of the melt-processable plasticized cellulose ester composition.

5. The melt-processable plasticized cellulose ester composition of claim 1 wherein the hydrocolloid is a polysaccharide hydrocolloid.

6. The melt-processable plasticized cellulose ester composition of claim 1 wherein the hydrocolloid is selected from the group consisting of an agar, an alginate, a carrageenan, a chitin, a cassia gum, a cellulose gum, a carboxymethyl cellulose, a hydroxyethyl cellulose, a hydroxypropyl cellulose, a methyl cellulose, a hydroxypropyl methyl cellulose, a fenugreek gum, a gellan gum, a guar gum, an acacia gum, a gum arabic, a gum ghatti, a gum karaya, a gum tragacanth, a konjac mannan, a linseed gum, a locust bean gum, a tara gum (aka Caesalpinia spinosa Gum), a tamarind gum, a tarrow gum, a plane tree gum, a xanthan gum, a soybean soluble polysaccharide, a pectin, a starch, a modified starch, and combinations thereof.

7. The melt-processable plasticized cellulose ester composition of claim 6, wherein the hydrocolloid is an acacia gum, a gum tragacanth, a modified starch or combinations thereof.

8. The melt-processable plasticized cellulose ester composition of claim 1 wherein the hydrocolloid is a food-compliant hydrocolloid.

9. The melt-processable plasticized cellulose ester composition of claim 1 wherein the plasticizer is present in an amount of from 1% to 40% by weight based on the total weight of said melt-processable plasticized cellulose ester composition.

10. The melt-processable plasticized cellulose ester composition of claim 1, wherein the plasticizer is polyethylene glycol or methoxy polyethylene glycol with an average molecular weight of from 300 to 500 Daltons.

11. The melt-processable plasticized cellulose ester composition of claim 1 wherein the cellulose ester comprises a cellulose acetate.

12. The melt-processable plasticized cellulose ester composition of claim 1, wherein the composition exhibits a degree of strain hardening (“SH”) that is in the range of 10% to 100%, or 20% to 100%, or 30% to 100%, or 40% to 100%, or 50% to 100% or 60% to 100% than the melt-processable cellulose ester composition without a hydrocolloid, wherein the SH is determined according to the procedure disclosed herein.

13. The melt-processable plasticized cellulose ester composition of claim 1, wherein the composition exhibits a maximum areal draw ratio (“Max ADR”) that is in the range of 10% to 50%, or 20% to 50%, or 30% to 50%, or 40% to 50% than the melt-processable cellulose ester composition without a hydrocolloid, wherein the Max ADR is determined according to the procedure disclosed herein.

14. A cellulose ester melt comprising or formed from or prepared using the melt-processable plasticized cellulose ester composition of claim 1.

15. A melt-formed article comprising or formed from or prepared using the melt-processable plasticized cellulose ester composition of claim 1 or the cellulose ester melt of claim 14.

16. The article of claim 15, wherein said article is a compression molded article, or an extruded article, or a profile extruded article, or a thermoformed article.

17. The article of claim 15, wherein the article is an oriented film, an oriented sheet, a foam sheet, or a fiber.

18. An article comprising a foam comprising, formed from or prepared using the melt-processable plasticized cellulose ester composition of claim 1 or the cellulose ester melt of claim 14.

19. The melt-processable plasticized cellulose ester composition of claim 1 wherein said hydrocolloid comprises acacia gum.

20. A pellet comprising the melt-processable plasticized cellulose composition of claim 1.
